(19) United States
(12) Patent Application Publication
(10) Pub. No.: US 2018/0067866 A1
(43) Pub. Date: Mar. 8, 2018

(54) TRANSLATE ON VIRTUAL MACHINE ENTRY

(71) Applicant: INTEL CORPORATION, Santa Clara, CA (US)

(72) Inventors: Vedvyas Shanbhogue, Austin, TX (US); Gilbert Neiger, Portland, OR (US); Barry E. Huntley, Hillsboro, OR (US)

(21) Appl. No.: 15/259,411

(22) Filed: Sep. 8, 2016

(51) Int. Cl. G06F 12/1009; G06F 11/07; G06F 12/14; G06F 9/455

(52) U.S. Cl. CPC G06F 12/1009; G06F 11/0712; G06F 11/073; G06F 2009/45583; G06F 11/0787; G06F 12/145; G06F 9/45558; G06F 11/0751

(57) ABSTRACT

A processor includes a core with virtualization support circuitry to, in response to a request to access an instruction, retrieve a logical address from a virtual machine control structure (VMCS) associated with a virtual machine. The logical address corresponds to the instruction to be accessed. The virtualization support circuitry may further translate the logical address to a guest virtual address; invoke translation circuitry to translate the guest virtual address to a guest physical address, and translate the guest physical address to a host physical address; and store at least one of the guest physical address or the host physical address in the VMCS.

The present disclosure relates to the field of emulation of instructions for a virtual machine and, in particular, to translation of an address upon virtual machine entry.

### BACKGROUND

A virtual machine manager (VMM) (or a hypervisor) of a processor emulates instructions executed by a guest virtual machine under its control, for example, to emulate a hardware device to which the virtual machine connects. Another example may include the VMM intercepting accesses to certain memory ranges and emulating the instructions in order to do security checks. Such a VMM may implement anti-virus/anti-malware policies which, by intercepting the instruction and emulating the instruction, the VMM may determine whether the instructions have any malicious side effects.

### BRIEF DESCRIPTION OF THE DRAWINGS

FIG. 1A is a block diagram of a computing device that may execute a virtual machine monitor and one or more virtual machines, according to an embodiment of the present disclosure.

FIG. 1B is a block diagram of a more detailed view of the processor and memory of the computing device of FIG. 1A.

FIG. 2 is a block diagram of a virtual machine control structure (VMCS), according to an embodiment of the present disclosure.

FIG. 3A is a block diagram illustrating translation of a guest virtual address to a guest physical address and of a guest physical address to a host physical address, according to an embodiment of the present disclosure.

FIG. 3B is a block diagram illustrating use of extended page tables (EPT) to translate a guest physical address to a host physical address, according to an embodiment of the present disclosure.

FIG. 4A is a block diagram illustrating determination of an offset used in translation of a logical to a linear address, according to an embodiment of the present disclosure.

FIG. 4B is a block diagram illustrating translation of a logical address to a linear address in protected mode, according to an embodiment of the present disclosure.

FIG. 4C is a block diagram illustrating translation of a logical address to a linear address in real mode, according to an embodiment of the present disclosure.

FIG. 4D is a block diagram depicting a segment selector, according to an embodiment of the present disclosure.

FIG. 4E is a block diagram depicting a segment register, according to an embodiment of the present disclosure.

FIGS. 5A and 5B are a flow diagram of a method of translating a logical address on virtual machine entry, according to an embodiment of the present disclosure.

FIGS. 6A and 6B are a flow diagram of a method of translating a logical address on virtual machine entry, according to another embodiment of the present disclosure.

FIG. 7A is a block diagram illustrating an in-order pipeline and a register renaming stage, out-of-order issue/execution pipeline according to one embodiment.

FIG. 7B is a block diagram illustrating a micro-architecture for a processor that perform translations on entries to a virtual machine.

FIG. 8 illustrates a block diagram of the micro-architecture for a processor that includes logic circuits to perform translation on entry to a virtual machine.

FIG. 9 is a block diagram of a computer system according to one implementation.

FIG. 10 is a block diagram of a computer system according to another implementation.

FIG. 11 is a block diagram of a system-on-a-chip according to one implementation.

FIG. 12 illustrates another implementation of a block diagram for a computing system.

FIG. 13 illustrates another implementation of a block diagram for a computing system.

### DESCRIPTION OF EMBODIMENTS

As part of the instruction emulation, a virtual machine monitor (VMM) translates linear addresses (e.g., guest virtual addresses, GVAs) used by the instruction to physical addresses such that the VMM can perform the accesses to those physical addresses on behalf of a guest virtual machine (VM). In order to emulate an instruction (or perform the accesses for other reasons), therefore, the VMM performs a series of operations on behalf of the VM. The series of operations incur considerable overhead in terms of processing resources. For example, the VMM determines segmentation including examining a segmentation state of the VM, and determines a paging mode of the VM at time of instruction invocation, including examining page tables set up by the VM and examining control registers and model-specific registers programmed by the VM. Following discovery of paging and segmentation modes, the VMM may first translate a logical address into a GVA (that is to be further translated), and detects any segmentation faults. This logical address may include a segment selector (for a segment in a linear address space of memory) and an offset within that segment.

The VMM may then translate the GVA to a guest physical address (GPA) and the GPA to a host physical address (HPA), including performing a page table walk in software. The page table walk may include loading a number of paging structure entries and extended page table (EPT) structure entries. The VMM may also evaluate these entries for terminal faults, and perform permission fault checks to determine read, write, and execute permissions. To perform these translations, the VMM software emulates page miss handler (PMH) circuitry, to perform these translations in software. To perform the related fault checks, the VMM software also models PMH and translation lookaside buffer (TLB) fault checking circuitry, which includes circuitry that checks for page faults, segmentation faults, and extended page table (EPT) violations, breakpoint detection and the like. Modeling these translations and fault checking, however, incurs considerable processing resource overheads, and slows down operation of the VMM.

In addition to the overheads of performing the translations and fault checking, the VMM instruction emulation may allow exploitation of security vulnerabilities of the VMM. Due to the VMM access of the memory in the guest, the guest could set up malformed page tables or configurations (e.g., through changing register values and the like) that may allow the guest to exploit a security vulnerability of the VMM upon the VMM accessing the memory in the guest.

Additionally, as processor architectures evolve, new paging features (e.g., shadow stacks, protection keys, and the like) are added to hardware of the processor. In order to continue to perform instruction emulation as just discussed, address translation-related software of the VMM is updated over and over again to stay up to date with emulating the functionality of the PMH and related fault checking circuitry. This inflates implementation costs, and may leave further security vulnerabilities when these updates are not performed.

In order to resolve the above-mentioned processing resource overheads and security vulnerabilities with the VMM access to the guest memory during emulation, the present disclosure describes how the VMM may turn over the above-mentioned translation and fault-checking to virtualization support circuitry before completing instruction emulation. In one embodiment, the VMM performs a translate-on-entry (TOE) virtual machine entry in which the VMM may employ translation circuitry like the PMH and the fault checking circuitry to perform the address translations and fault checking and to generate a GPA and an HPA to be used in emulating an instruction executed by the VM. To do so, the VMM may trigger the virtualization support circuitry of a processor so that the virtualization support circuitry performs translations and fault checking in lieu of the VMM performing these translations and fault checking. The virtualization support circuitry may also retrieve data from and store data to a data structure known as a virtual machine control structure (VMCS) as a way to exchange translation-related data with the VMM, as will be explained in detail. The virtualization support circuitry may ultimately perform an exit to the VMM after either successful translation of an address or upon detecting a fault, and storing an identified reason for the exit in the VMCS.

More particularly, the VMM may set a bit flag of a translate-on-entry control field of the VMCS associated with the virtual machine to perform a TOE VM entry. The VMM may also store a logical address in the VMCS, where the logical address corresponds to an instruction to be emulated for the VM machine. Alternatively, the VMM may store a linear address (such as a guest virtual address) in the VMCS, wherein the linear address corresponds to the instruction to be emulated.

The virtualization support circuitry may load the segment registers, control registers, MSR and other guest-register-backed and non-register-backed state in the processor hardware from the corresponding guest state fields in the VMCS. The virtualization support circuitry may further, responsive to detecting that the bit flag of the translate-on-entry control field of the VMCS is set, translate, to a GVA, the logical address retrieved from the VMCS. In one embodiment, the virtualization support circuitry may perform this translation through invoking address generation circuitry of the processor. The virtualization support circuitry may further invoke translation circuitry (like a PMH) to translate the GVA to a guest physical address (GPA) and to translate the GPA to a host physical address (HPA). The virtualization support circuitry may then store the GPA or the HPA (or both) in the VMCS in relation to the logical address. Following storing of the translation information the virtualization support circuitry may then exit to the VMM instead of continuing execution of instructions in the VM. If faults occur in the translation process (such as a page fault, a segmentation fault, or an extended page table (EPT) violation, or the like), the virtualization support circuitry may store a record of the fault in the VMCS in relation to the logical address and perform an exit to the VMM. The VMM may then retrieve, from the VMCS, the GPA or the HPA for emulating an instruction for the virtual machine if no fault occurred during the translation. If a fault was detected then the VMM may retrieve the fault information from the VMCS and process the fault appropriately as part of the instruction emulation.

In an alternative embodiment, after a TOE VM entry, the VMM may trigger the virtual support circuitry to perform a series of translations, one for each of multiple logical addresses. In this embodiment, the VMM may also set a bit flag of a translate-on-entry control field of the VMCS. The VMM may further populate a table stored in memory with the multiple logical addresses corresponding instructions to be emulated for the virtual machine. The VMM may also store, in the VMCS, an address of the table of multiple logical addresses that the virtualization support circuitry may access along with a count that specifies the number of logical addresses in the table that require translation. The VMM may also set up this table in memory and maintain control of the table. When the VMM needs to translate a set of logical addresses, VMM may write the set of logical addresses into this table. The virtualization support circuitry may then, for each of at least some of the logical addresses, and in response to detecting that the bit flag of the translate-on-entry control field is set, translate the logical address (a next logical address retrieved from the table) to a guest virtual address (GVA). The virtualization support circuitry may then translate the GVA to a GPA, translate the GPA to a HPA, and store the GPA or the HPA (or both) in the table in relation to the logical address. The virtualization circuitry may repeat this process for each logical address as long as no fault is detected. After the virtualization support circuitry exits back to the VMM, the VMM may further retrieve, from the table, one of a plurality of guest physical addresses or a plurality of host physical addresses for emulating an instruction for the virtual machine.

In the alternative embodiment, the virtualization support circuitry may also indicate, in the table, each logical address as valid that was successfully translated. If, however, any of the translations result in a fault, the virtualization support circuitry may store a record of the fault in the VMCS in relation to the logical address, load a VMM state from the VMCS, and exit to the VMM. The VMM may then know which logical addresses may be used for instruction emulation and which ones resulted in a fault, and thus use the fault information or the translated GPA and/or HPA for instruction emulation. The use of the table in this alternative embodiment allows the overhead of entry and exit from the virtualization support circuitry to be amortized over multiple translations and reduce overheads even further, e.g., by avoiding the need to do multiple entries and exits, one each for each logical address.

In another embodiment, the VMM may not emulate an instruction but may access the instruction for another purpose. In one example, a hardware device that is powered down may generate a fault exit to the VMM when accessed. (The VMM may also power down certain hardware devices.) When the VM is notified of a powered-down fault due to a failed access, the VMM may use the GVA of the memory access and translate the GVA to an HPA to determine the hardware device to which access was attempted. Subsequently, the VMM may power up that hardware device and re-enter the virtual machine such that the instruction is retried. Now, because the device is powered ON, the instruction may be successfully emulated on behalf of the virtual machine.

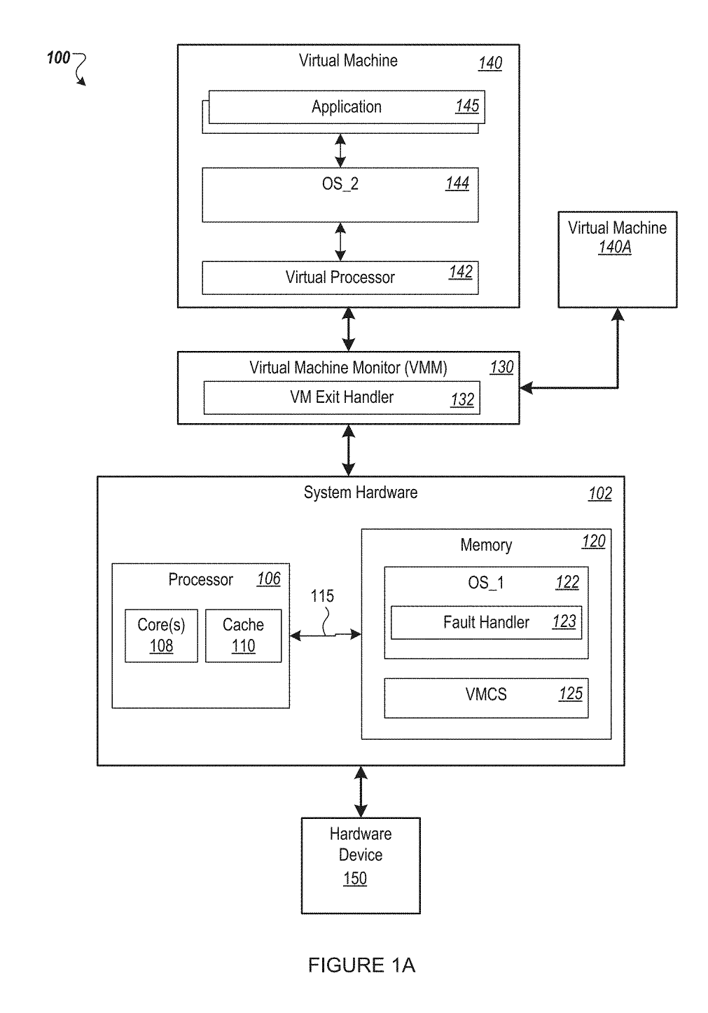

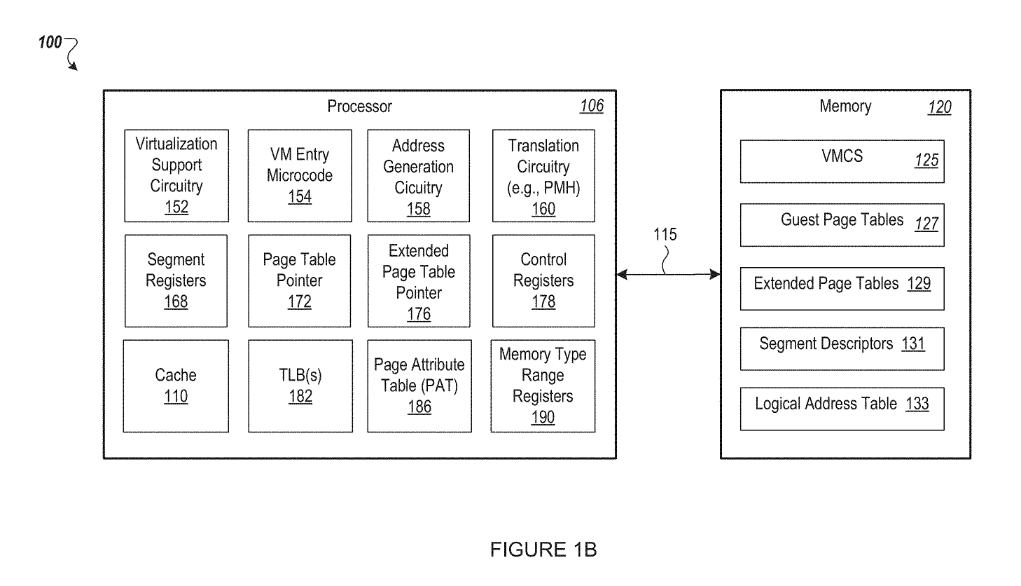

FIG. 1A is a block diagram of a computing device 100 that may execute a virtual machine monitor (VMM) 130 (which may include a VM exit handler 132) and one or more virtual machines 140, 140A, according to an embodiment of the present disclosure. The computing device may also include or connect to a hardware device 150 such as an integrated hardware device, an I/O device, or other peripheral device, for example.

In various embodiments, a “computing device” may be or include, by way of non-limiting example, a computer, workstation, server, mainframe, virtual machine (whether emulated or on a “bare-metal” hypervisor), embedded computer, embedded controller, embedded sensor, personal digital assistant, laptop computer, cellular telephone, IP telephone, smart phone, tablet computer, convertible tablet computer, computing appliance, network appliance, receiver, wearable computer, handheld calculator, or any other electronic, microelectronic, or microelectromechanical device for processing and communicating data.

In one embodiment, the computing device 100 may include system hardware 102. The system hardware 102 may include, for example, a processor 106 including one or more cores 108 and cache 110. The system hardware 102 may further include memory 120 to store an image of an operating system 122 (which may include a fault handler 123), and a virtual machine control structure (VMCS) 125 that the VMM 130 uses to create, control, and manage the virtual machines 140 and 140A. The fault handler 123 may handle any number of faults that result from the image of the operating system running on the processor 106. For example, these faults may include a segment not present (#NP), a stack-segment fault (#SS), a general protection fault (#GP), or a page fault (#PF), as just a few examples. The system hardware 102 may further include a system bus 115 (which may also be a memory bus) between the processor 106 and the memory 120.

Each virtual machine 140 and 142A may include a virtual processor 142 that is emulated by underlying system hardware 102, an operating system 144, and one or more applications 145 that the operating system 144 executes. As mentioned, the virtual machine 140 may connect to the hardware device 150 to send commands to direct the hardware device 150. To do so, the VMM 130 may emulate one or more instructions (such as device driver instructions) to provide the virtual machine 140 access to the hardware device 150.

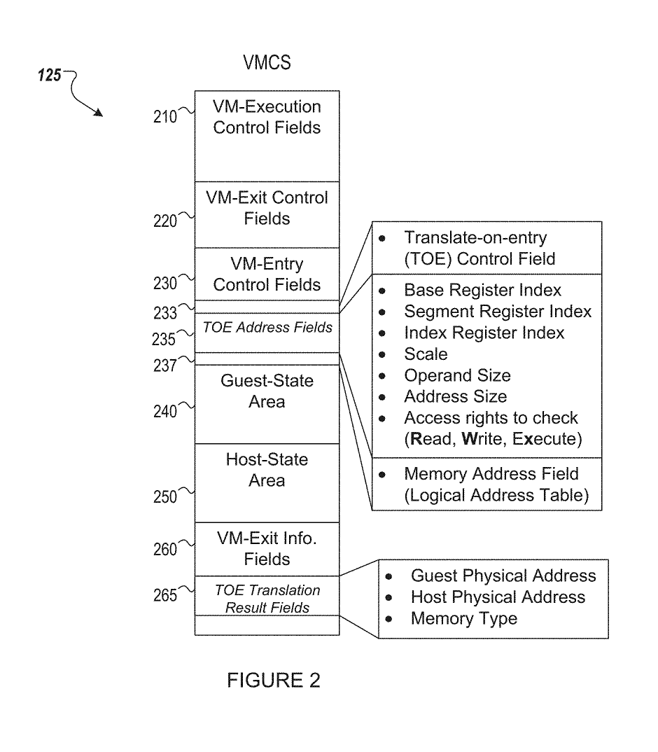

With additional reference to FIG. 1B, the system hardware of the processor 106 and memory 120 of the computing device 100 of FIG. 1A are shown in more detail. As discussed, the memory 120 may store the VMCS 125, a detailed layout of which is depicted in FIG. 2. The memory 120 may further store guest page tables 127 for use in translating guest virtual addresses to guest physical addresses, extended page tables 129 used for translating guest physical addresses to host physical addresses, segment descriptors 131, and a logical address table 133, which are discussed in detail below.

In one embodiment, the processor 106 may, in addition to the core(s) 108 and the cache 100, further include virtualization support circuitry 152, VM entry microcode 154, address generation circuitry 158, translation circuitry 160 (such as a page miss handler (PMH), fault detection and generation circuitry, and the like), segment registers 168, a page table pointer 172, an extended page table pointer 176, control registers 178, one or more translation lookaside buffers (TLB s) 182, a page attribute table (PAT) 186, and memory type range registers (MTRR) 190. This list of hardware, registers, and pointers is not exhaustive; a future processor may include more or fewer of such registers and pointers.

The VMM 130 is a software layer responsible for creating, controlling, and managing the virtual machines. The VMM may be executed on the system hardware 102 supporting the virtual-machine extension (VMX) or similar architecture. The VMM has full control of the processor(s) and other platform hardware of the system hardware 102. The VMM presents guest software (e.g., a virtual machine) with an abstraction of the virtual processor 142 and allows the virtual processor 142 to execute on the processor 106. A VMM 130 is able to retain selective control of processor resources, physical memory, interrupt management, and I/O.

Each virtual machine is a guest software environment that supports a stack including the operating system 144 and application software. Each VM may operate independently of other virtual machines and uses the same interface to processor(s), memory, storage, graphics, and I/O provided by a physical platform. The software stack acts as if the software stack were running on a platform with no VMM. Software executing in a virtual machine operates with reduced privilege or its original privilege level such that the VMM can retain control of platform resources per a design of the VMM or a policy that governs the VMM, for example.

The VMM 130 may begin the VMX root mode of operation when the processor 106 executes a VMXON instruction. The VMM starts guest execution by invoking a VM entry instruction. The VMM invokes a VMLAUNCH instruction for execution for a first VM entry of a virtual machine. The VMM invokes a VMRESUME for execution for all subsequent VM entries of that virtual machine. The VMLAUNCH or VMRESUME instructions do a VM entry to the virtual machine associated with a current VMCS 125.

During execution of a virtual machine, various operations or events (e.g., hardware interrupts, software interrupts, exceptions, task switches, and certain VMX instructions) may cause a VM exit to the VMM 130, after which the VMM regains control. VM exits transfer control to an entry point specified by the VMM, e.g., a host instruction pointer. The VMM may take action appropriate to the cause of the VM exit and may then return to the virtual machine using a VM entry. The VMM can also leave the VMX root mode of operation by executing a VMXOFF operation.

These transitions of a VM entry and a VM exit are controlled by the VMCS 125 data structure stored in the memory 120. The processor 106 controls access to the VMCS 125 through a component of processor state called the VMCS pointer (one per virtual processor) that is setup by the VMM using the VMPTRLD instruction. The VMM may configure a VMCS using VMREAD, VMWRITE, and VMCLEAR instructions. A VMM may use a different VMCS for each virtual processor that it supports. For a virtual machine with multiple virtual processors 142, the VMM 130 could use a different VMCS 125 for each virtual processor.

With additional reference to FIG. 2, the VMCS 125 may include six logical groups of fields: VM-execution control fields 210, VM-exit control fields 220, VM-entry control fields 230 (which may include a translate-on-entry (TOE) control field 233), TOE address fields 235, a memory address field 237 for the logical address table 133), a guest-state area 240, a host-state area 250, and a VM-exit information fields 260 (which may include TOE translation result fields 265). These six logical groups of fields are merely exemplary and future processors may have more or fewer groups of fields.

In one embodiment, the VM-execution control fields 210 may define how the processor 106 should react in response to different events occurring in the VM 140. In one embodiment, the VM-exit control fields 120 may define what the processor 106 should do when it exits from the virtual machine 140, e.g., store a guest state of the VM in the VMCS 125 and load the VMM (or host) state from the VMCS 125. The VMM state may be a host state comprising fields that correspond to processor registers, including the VMCS pointer, selector fields for segment registers, base-address fields for some of the same segment registers, and values of a list of model-specific registers (MSRs) that are used for debugging, program execution tracing, computer performance monitoring, and toggling certain processor features.

In one embodiment, the VM-entry control fields 230 may define what the processor 106 should do upon entry to the virtual machine 230, e.g., to conditionally load the guest state of the virtual machine 140 from the VMCS 125, including debug controls, and inject an interrupt or exception, as necessary, to the virtual machine during entry.

In one embodiment, the guest-state area 340 may be a location where the processor 106 stores a VM processor state upon exits from and entries to the virtual machine 140.

In one embodiment, the host-state area 250 may be a location where the processor 106 stores the VMM processor (or host) state upon exit from the virtual machine 140.

In one embodiment, the VM-exit information fields 260 may be a location where the processor 106 stores information describing a reason of exit from the virtual machine.

Accordingly, when a VM exit occurs, hardware of the processor 106 may save a guest state of the virtual machine to the guest-state area 240 of the VMCS 125. The hardware may also save the exit reason and exit qualification to the VM-exit information fields 260 of the VMCS 125. The processor 106 may also load the host state from the VMCS, which includes a host instruction pointer (HOST RIP). The processor 106 may then start executing the VMM 130 from the host instruction pointer, which also invokes the VM exit handler 132, which is a software function of the VMM that may perform various VM exit-related operations. If the VM exit was following a TOE entry, then the processor 106 has completed the translation and provided the translation information or fault information for the VMM to process as part of its instruction emulation operation.

In one embodiment, in order to emulate an instruction on behalf of a virtual machine, the VMM 130 may need to translate a linear address (e.g., a GVA) used by the instruction to a physical address such that the VMM 130 can access data at that physical address. In order to perform that translation, the VMM 130 may need to first determine paging and segmentation including examining a segmentation state of the virtual machine (VM) 140. The VMM may also determine a paging mode of the VM at time of instruction invocation, including examining page tables set up by the VM and examining the control registers 178 and model-specific registers programmed by the VM 140. Following discovery of paging and segmentation modes, the VMM 130 may generate a guest virtual address (GVA) for a logical address, and detect any segmentation faults.

Assuming no segmentation faults are detected, the VMM 130 may translate the GVA to a guest physical address (GPA) and the GPA to a host physical address (HPA), including performing a page table walk in software. To perform these translations in software, the VMM 130 may load a number of paging structure entries and extended page table (EPT) structure entries originally set up by the virtual machine 140 into general purpose registers. Once these paging and EPT structure entries are loaded, the VMM 130 may perform the translations by modeling translation circuitry such as a page miss handler (PMH).

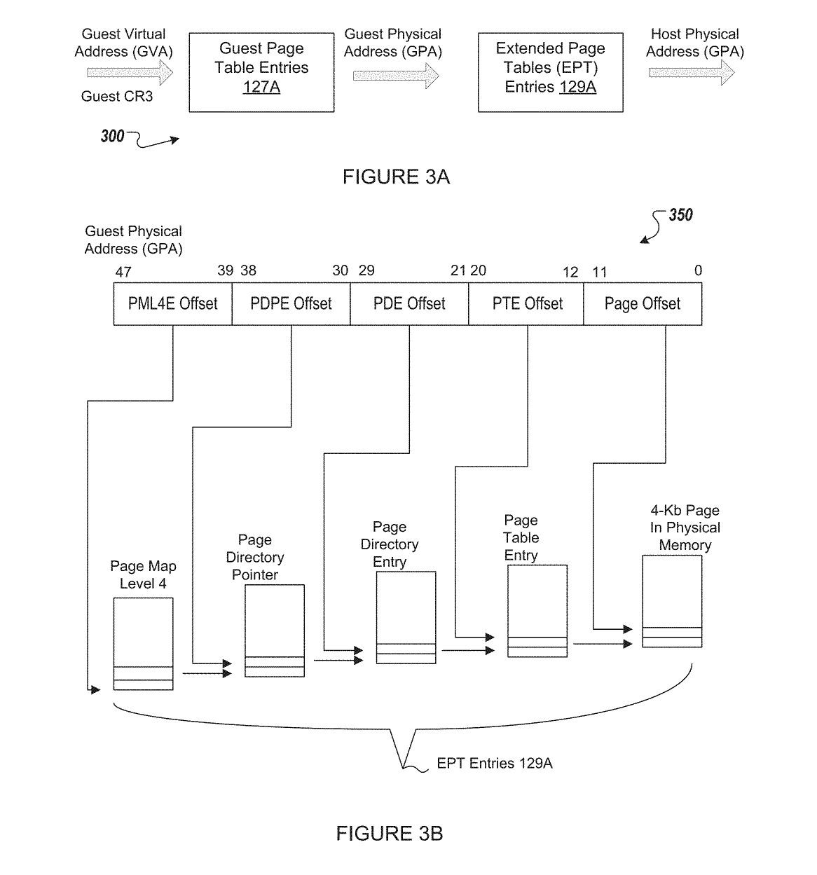

More specifically, with reference to FIG. 3A, the VMM 130 may load a plurality of page table entries 127A from the guest page tables 127 and a plurality of extended page table entries 129A from the extended page tables (EPT) 129 that were established by the virtual machine 140. The VMM 130 may then perform translation by walking (e.g. sequentially searching) through the guest page table entries 127A to generate a GPA from the GVA. The VMM 130 may then use the GPA to walk (e.g., sequentially search) the extended page tables (EPT) 129 to generate the HPA associated with the GPA.

Use of the EPT 129 is a feature that can be used to support the virtualization of physical memory. When EPT is in use, certain addresses that would normally be treated as physical addresses (and used to access memory) are instead treated as guest-physical addresses. Guest-physical addresses are translated by traversing a set of EPT paging structures to produce physical addresses that are used to access physical memory.

FIG. 3B is a block diagram 350 illustrating how the VMM 130 may walk the extended page table entries 129A to translate a guest physical address to a host physical address, according to one embodiment of the present disclosure. For example, the guest physical address (GPA) may be broken into a series of offsets, each to search within a table structure of a hierarchy of the EPT entries 129A. In this example, the EPT from which the EPT entries are derived includes a four-level hierarchal table of entries, including a page map level 4 table, a page directory pointer table, a page directory entry table, and a page table entry table. (In other embodiments, a different number of levels of hierarchy may exist within the EPT, and therefore, the disclosed embodiments are not to be limited by a particular implementation of the EPT.) A result of each search at a level of the EPT hierarchy may be added to the offset for the next table to locate a next result of the next level table in the EPT hierarchy. The result of the fourth (page table entry) table may be combined with a page offset to locate a 4 Kb page (for example) in physical memory, which is the host physical address.

With additional reference to FIG. 1B, in one embodiment, a TLB 182 is used to help with address translations. The processor 106 may therefore need to update the TLB 182 for consistency upon translation of a GVA to a physical address (whether a GPA or an HPA). The TLB 182 is a cache that memory management hardware uses to improve virtual address translation speed. The TLB 182 may be present in any hardware that utilizes paged or segmented virtual memory.

In various embodiments, the TLB 182 has a fixed number of slots containing page table entries and segment table entries, where page table entries map virtual addresses to physical addresses and intermediate table addresses, while segment table entries map virtual addresses to segment addresses, intermediate table addresses, and page table addresses. The virtual memory is the memory space as seen from a process, where the virtual memory address space may be split into pages of a fixed size (in paged memory), or into segments of variable sizes (in segmented memory), although individual segments of segmented memory may be treated as paged memory as well. The page table, which may be stored in main memory, keeps track of where the virtual pages are stored in the physical memory. The TLB is a cache of the page table, and may represent only a subset of the page table contents. These contents may be stored in a portion of the TLB 182 associated with a corresponding address space identifier (ASID) for an address space set up for the virtual machine 140.

Referencing the physical memory addresses (such as the GPA and HPA), the TLB 182 may reside between the processor 106 and the cache 110, between the cache 110 and primary storage memory, or between levels of a multi-level cache. The placement determines whether the cache 110 uses physical or virtual addressing. If the cache 110 is virtually addressed, requests may be sent directly from the processor 106 to the cache 110, and the TLB 182 is accessed only on a cache miss. If the cache 110 is physically addressed, the processor 106 does a TLB lookup on every memory operation and the resulting physical address is sent to the cache 110.

The TLB 182 may be implemented as content-addressable memory (CAM). A CAM search key is the virtual address and the search result is a physical address, such as a GPA or HPA (depending on which one the search key requires). If the requested address is present in the TLB, the CAM search yields a match quickly and the retrieved physical address can be used to access memory. This is called a TLB hit. If the requested address is not in the TLB, it is a miss, and the translation proceeds as discussed previously with reference to FIGS. 3A and 3B. The EPT page walk and guest page table walk needed for translation to an HPA may require a lot of time when compared to the processor speed, as it involves reading the contents of multiple memory locations and using the contents to compute the host physical address. After the host physical address is determined by the page walk, the virtual-address-to-physical-address mapping is entered into the TLB 182 as a TLB entry for a current ASID.

In one embodiment, the TLB may not be coherent with the page table and extended page table structures. Hence in some implementations of the TLB, the information cached in the TLB may not match the information in the page tables. For example, the TLB may have cached a translation of virtual addresss X to physical address Y by walking the page tables. However, subsequently, the operating system may have modified the page tables such that another walk would result in virtual address X being mapped to physical address Z. Such a TLB entry is called a stale TLB entry as it is not consistent with the current state of the page tables.

In one embodiment, the VMM 130 may also evaluate the page table structure entries for terminal faults, accumulate read, write and execute permissions, and perform permission fault checks. To perform the related fault checks, the VMM 130 may also model PMH and translation lookaside buffer (TLB) fault checking circuitry, which includes checks for page faults, segmentation faults, and extended page table (EPT) violations and the like. Modeling these translations and fault checking, however, incurs considerable processing resource overheads, and slows down operation of the VMM.

With additional reference to FIG. 2, the disclosed virtualization support circuitry 152 may instead perform these translations and fault checking operations at a faster speed and without need of being updated. In order to employ the virtualization support circuitry 152 in this way, the VMM 130 may, responsive to needing to perform an address translation, set a bit flag of the translate-on-entry (TOE) control field 233 (FIG. 2) of the current VMCS 125 as a signal to the virtualization support circuitry 152 to perform a translation on next VM entry. The VMM 130 may then invoke a VMRESUME instruction, which when executed, establishes a guest paging and segmentation state from the guest state area 240 of the VMCS 125.

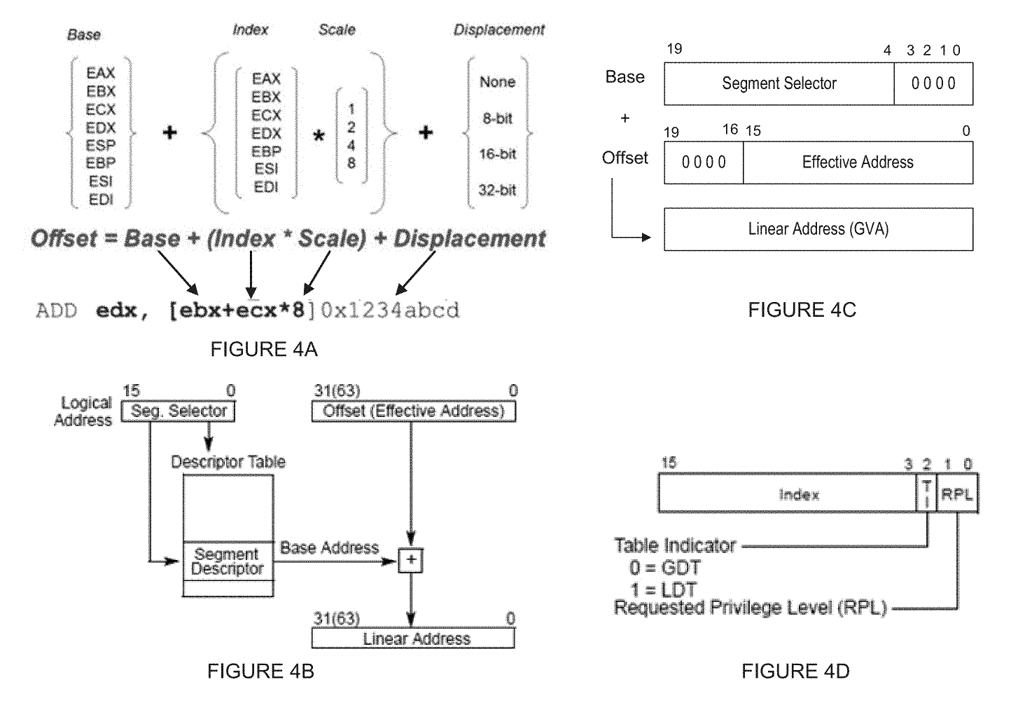

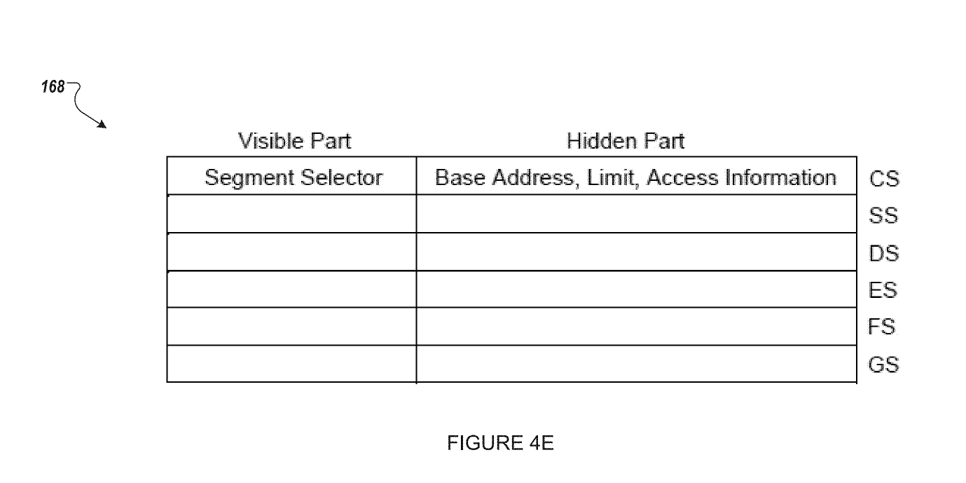

In one embodiment, the VMM 130 may also store a logical address in the TOE address fields 235 (FIG. 2) of the VMCS 125. (Alternatively, the VMM 130 may store a guest virtual address in the address fields 235 of the VMCS 125.) Recall that the logical address includes a segment selector (for a segment in a linear address space of memory) and an offset within that segment. Accordingly, in one example, the logical address may be programmed into the TOE address fields 235 with a base register index, a segment register index, an index register index, a scale, an operand size, and an address size. As shown in FIG. 4A, the offset is computed as content of base register plus the content of the index register multiplied by the scale plus displacement. So if an instruction were to be encoded with an address [EBX+EAX*8+32] and the content of EBX is 5 and the content of EAX is 1, then the offset is 5+(1*8)+32=45. The VMM 130 may also store, in the TOE address fields 235, access rights (such as read (R), write (W), and execute (X) permissions) required to access data stored at the corresponding physical address. The information in the TOE address fields may be obtained, in part, from the segment descriptors 131 as will be explained in more detail.

In one embodiment, the virtualization support circuitry 152 includes any hardware of the processor 106, whether on a core 108 or off the core, used to perform translation of a logical address to a guest virtual address (GVA) (where necessary), of the GVA to a guest physical address (GPA), and of the GPA to a host physical address (HPA), along with fault checking the GPA and HPA and corresponding permissions. The virtualization support circuitry 152 may perform this translation and fault checking in response to detecting that the bit flag of the translate-on-entry (TOE) control field 233 is set. Accordingly, the TOE control field 233 acts as a signal, encoded by the VMM 130, to the virtualization support circuitry 152 to perform the disclosed translation on entry. In one embodiment, the VM entry with the TOE control field 233 set can be used as a hint by the processor 106 to load a subset of guest state information from the guest state area 240 in the VMCS 125. The subset may be the subset of the guest state that is needed to perform the translation of the address specified in the TOE address fields 235, and thus speed up the TOE VM entry. To avoid reporting the translation from a stale TLB entry, the virtualization support circuitry may first invalidate any cached translation information for this GVA from the TLB prior to invoking the translation circuitry 160 to translate the GVA to GPA and/or HPA.

To perform the translation on entry, the virtualization support circuitry 152 may execute the VM entry microcode 154, and may further invoke the address generation circuitry 158 and the translation circuitry 160 (e.g., PMH). The virtualization support circuitry 152 may also retrieve information from the TOE address fields 235 for the logical address stored in the VMCS 125. The virtualization support circuitry may invoke the address generation circuitry 158 to use the information in these TOE address fields 235 to translate the logical address to a guest virtual address (GVA), as will be explained. The information in the TOE address fields 235 may relate to addressing in segmented memory.

With reference to FIGS. 4A through 4D, in one embodiment, segmentation provides a mechanism for dividing the addressable memory space (called the linear address space) accessible by the processor 106 into smaller protected address spaces called segments. Segments can be used to hold the code, data, and stack for an application 145 or to hold system data structures (such as a Task State Segment (TSS) or a Local Descriptor Table (LDT)). If more than one application (or task) is running on the processor 106, each application can be assigned its own set of segments. The processor 106 then enforces the boundaries between these segments and insures that one application does not interfere with the execution of another application by writing into the other application's segments. The segmentation mechanism also allows typing of segments so that the operations that may be performed on a particular type of segment can be restricted.

The segments in a computing system are contained in the processor's linear address space. To locate a byte in a particular segment, a logical address (also called a far pointer) is provided. A logical address includes a segment selector and an offset. As shown in FIG. 4A, the offset be made up of the sum of a base value, an index multiplied by a scale, and a displacement. The segment selector (such as illustrated in FIG. 4D) is a unique identifier for a segment. The segment selector may include, for example, a two-bit requested privileged level (RPL), a 1-bit table indicator (TI), and a 13-bit index. Among other things, the segment selector provides an offset into a descriptor table (such as the global descriptor table (GDT) or a local descriptor table (LDT)) to a data structure called a segment descriptor 131, as shown in FIG. 4B. Each segment has a segment descriptor, which specifies the size of the segment, the access rights and privilege level for the segment, the segment type, and the location of the first byte of the segment in the linear address space (called the base address of the segment). The offset part of the logical address is added to the base address for the segment to locate a byte within the segment, as illustrated in FIG. 4B. The base address plus the offset thus forms a linear address in the processor's linear address space. In one embodiment, the translation illustrated in FIG. 4B is for protected mode addressing (outside 64-bit), and the translation illustrated in FIG. 4C (where the offset includes an effective address) is for a real mode, which is characterized by a 20-bit segmented address space.

Accordingly, the virtualization support circuitry 152 may invoke the address generation circuitry 158, in one embodiment, to perform a translation of the logical address to a linear address, also referred to herein as the guest virtual address (GVA), as just explained. To do so, the address generation circuitry 158 may use the offset in the segment selector to locate the segment descriptor for the segment in the GDT or LDT and reads the segment selector into the processor. (This step may also be performed when a new segment selector is loaded into a segment register.) The address generation circuitry 158 may then examine the segment descriptor to check the access rights and range of the segment to insure that the segment is accessible and that the offset is within the limits of the segment. The address generation circuitry 158 may then add the base address of the segment from the segment descriptor to the offset to form the GVA.

More specifically, to check access rights, the address generation circuitry 158 may perform a privilege check, max(CPL, RPL)≦DPL, where CPL is the current privilege level (found in the lower 2 bits of a code segment (CS) register), RPL is the requested privilege level from the segment selector, and DPL is the descriptor privilege level of the segment (found in the descriptor). All privilege levels may be integers in the range 0-3, where the lowest number corresponds to the highest privilege, for example.

If the inequality is false, the address generation circuitry 158 may generate a general protection (GP) fault. Otherwise, the address translation continues. The address generation circuitry 158 may then take a 32-bit or 16-bit offset, for example, and compare the offset against a segment limit specified in the segment descriptor. If the offset is larger, a GP fault is generated. Otherwise, the address generation circuitry 158 adds the 24-bit segment base (or another size base, specified in the segment descriptor) to the offset, creating the GVA. The privilege check may be performed only when the segment register is loaded, because segment descriptors 131 may be cached in hidden parts of the segment registers 168 (FIG. 4E).

FIG. 4E is a block diagram depicting a segment register 168, according to an embodiment of the present disclosure. To reduce address translation time and coding complexity, the processor 106 may provide segment registers 168 for holding up to 6 segment selectors. Each of the segment registers support a specific kind of memory reference (code, stack, or data). For virtually any kind of program execution to take place, at least the code-segment (CS), data-segment (DS), and stack-segment (SS) registers are loaded with valid segment selectors. The processor 106 may also provide three additional data-segment registers (ES, FS, and GS), which can be used to make additional data segments available to the currently executing application (or task).

For an application to access a segment, the processor 106 must have first loaded a segment selector for the segment in one of the segment registers 138. So, although a computing system can define thousands of segments, only six (“6”) may be available for immediate use. Other segments can be made available by loading their segment selectors into these registers during program execution.

Every segment register has a “visible” part and a “hidden” part. (The hidden part is sometimes referred to as a “descriptor cache” or a “shadow register.”) When a segment selector is loaded into the visible part of a segment register, the processor also loads the hidden part of the segment register with the base address, segment limit, and access control information from the segment descriptor pointed to by the segment selector. The information cached in the segment register (visible and hidden) allows the processor to translate addresses without taking extra bus cycles to read the base address and limit from the segment descriptor. In systems in which multiple processors have access to the same descriptor tables, it is the responsibility of software to reload the segment registers when the descriptor tables are modified. If this is not done, an old (e.g., stale) segment descriptor cached in a segment register may be used after its memory-resident version has been modified.

Once the virtualization support circuitry 152 has the guest virtual address (GVA) corresponding to the logical address, the virtualization support circuitry 152 may then invoke the translation circuitry 160 (such as a PMH) to translate the GVA to a guest physical address (GPA) and the GPA to a host physical address (HPA). In one embodiment, this invocation may be done by the VM entry microcode 154 invoking a hardware operation sequence in response to detecting a bit flag set in the TOE control field 233 of the VMCS 125. For example, the translation circuitry 160 may translate the GVA to a guest physical address (GPA) using the page table pointer (PTP) 172 that points to a base of the pages tables 127, as discussed with reference to FIG. 3A. The PTP 172 may be a guest physical address of the base of a page table in the page tables 127. After translation of the GVA to the GPA, the translation circuitry 160 may translate the GPA to a host physical address HPA using the extended page table pointer (EPTP) 176 that points to a location within the extended page tables (EPT) 129, as discussed with reference to FIGS. 3A and 3B. The EPTP 176 contains the address of the base of an EPT page mapping level 4 entry (PML4E) table as well as other EPT configuration information. The PML4E table is a first of the extended page tables 129 entries that starts the page walk, resulting in a pointer that will be added to an offset for the next table as discussed with reference to FIG. 3B. Once the page walk is completed through the EPT 129, the HPA, which corresponds to a page in physical memory, is generated. The virtualization support circuitry 152 may store the GPA and the HPA in the TOE translation result area 265 of the VMCS, and exit to give control back to the VMM 130. The exit may be performed by the virtualization support circuitry 152 loading a VMM state from the VMCS 125 and performing an exit to the VMM that has been loaded.

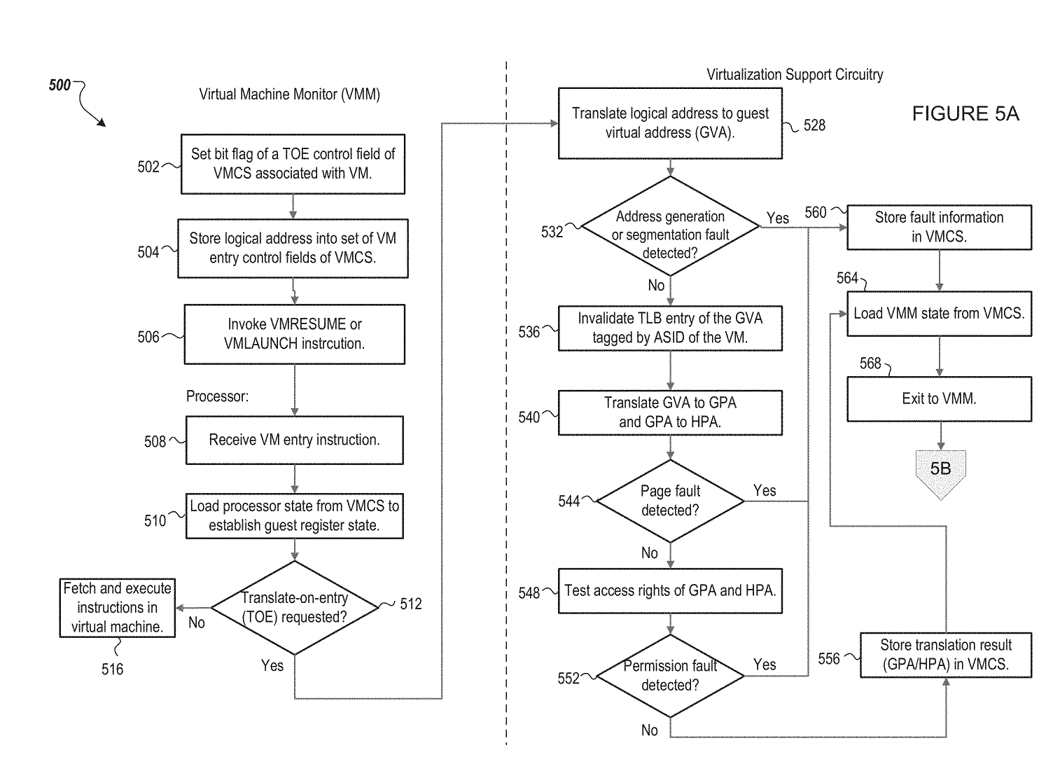

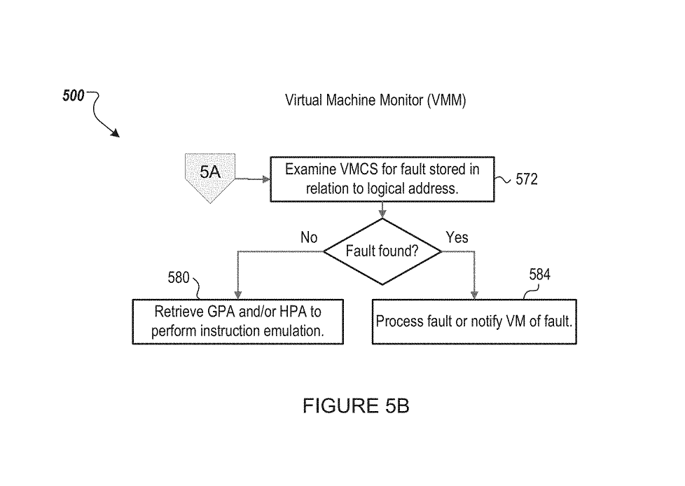

As will be discussed in more detail with reference to FIG. 5, if a fault is detected, the virtualization support circuitry 152 may store a reason for the fault in the VMCS 125 and exit to the VMM 130 without completion of the translation. Assuming there was no fault during the address translation process, the VMM 130 may retrieve the GPA and/or the HPA for use in instruction emulation or determine that the translation process resulted in a fault.

The memory type range registers (MTRR) 190 may be model-specific registers (MSRs) in one embodiment, and may be used to assign memory types to regions of memory. For example, caching of I/O accesses can be avoided by using MTRRs to map the address space used for the memory-mapped I/O as uncacheable. The page attribute table (PAT) 186 may extend the page-table format to allow memory types to be assigned to regions of physical memory based on linear address (GVA) mappings. The PAT 186 is a companion feature to the MTRRs; that is, the MTRRs 190 may allow mapping of memory types to regions of the physical address space, where the PAT 186 allows mapping of memory types to pages within the linear address space. The MTRRs may be used for statically describing memory types for physical ranges, and are typically set up by a system BIOS. The PAT may extend functions of the page-level cache disable (PCD) and page-level write-through (PWT) bits in page tables to allow multiple memory types that can be assigned with the MTRRs to also be assigned dynamically to pages of the linear address space.

As discussed, the translation circuitry 160 may access page table and EPT structures that were established by the virtual machine 140 for performing translations to a GPA and/or HPA. In one embodiment, the translation circuitry may also access the PAT 186 and MTRRs 190 in a computation of the memory type that the processor 106 should use to access the HPA as a result of the translation. The virtualization support circuitry may then store the memory type in one of the TOE translation result fields 265 of the VMCS 125 so the VMM 130 can access that memory type when it reads out the GPA or HPA for use in instruction emulation.

In one embodiment, the computation of the memory type is based on the effective memory type used to access the EPT in response to a memory access using a GPA. This effective memory type is based on the value of bit 30 (cache disable—CD) in a control register 178, register CR0, the last EPT paging-structure entry used to translate the GPA (for example, either an EPT PDE with bit 7 set to 1 or an EPT PTE); and the PAT memory type.

In one embodiment, the PAT memory type depends on the value of a control register 178, CR0.PG. If CR0.PG=0, the PAT memory type is WB (writeback). If CR0.PG=1, the PAT memory type is the memory type selected from the IA32_PAT MSR.

Additionally, in one embodiment, the EPT memory type may be specified in bits 5:3 of the last EPT paging-structure entry: 0=UC; 1=WC; 4=WT; 5=WP; and 6=WB, wherein WB, WT, and WC are all cacheable. If CR0.CD=0, the effective memory type depends upon the value of bit 6 of the last EPT paging-structure entry. If the value is 0, the effective memory type is the combination of the EPT memory type and the PAT memory type, using the EPT memory type in place of the MTRR memory type. If the value is 1, the memory type used for the access is the EPT memory type. The PAT memory type is ignored. If CR0.CD=1, the effective memory type is uncacheable (UC).

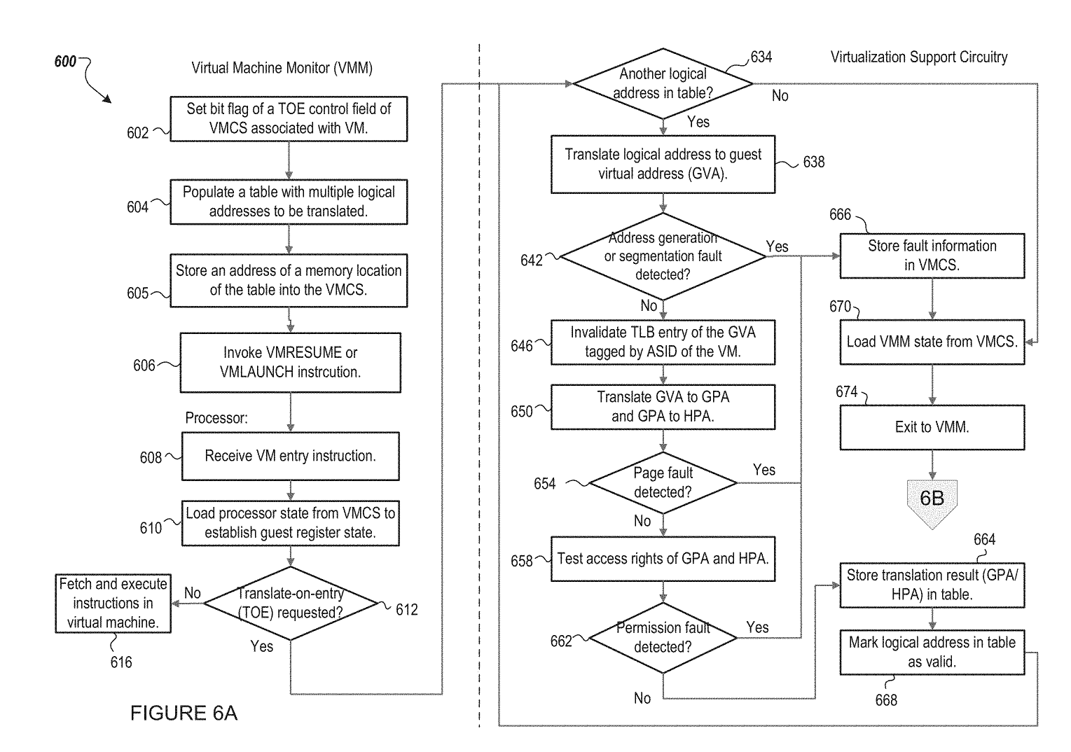

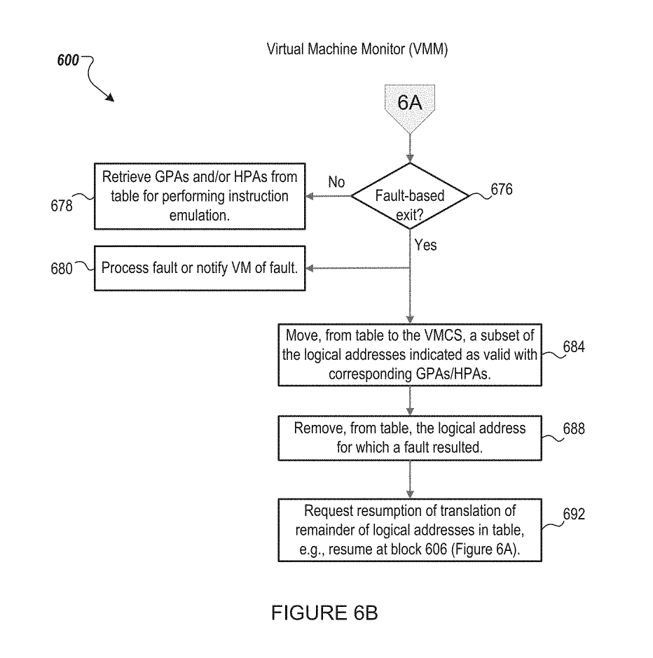

In another embodiment, the VMM 130 may store multiple logical addresses into the logical address table 133, instead of storing one logical address at a time into the VMCS 125. The VMM 130 may then store, in the memory address field 237 of the VMCS 125, an address of the logical address table 133 in the memory 120. In this example, the virtualization support circuitry 152 may then access the logical address table 133 (at the memory address stored in the VMCS) to sequentially retrieve logical addresses for translation. The virtualization support circuitry 152 may translate a next retrieved logical address (from the table) to a GVA before invoking the translation circuitry 158 to generate the corresponding GPA and HPA from the GVA. The corresponding GPA/HPA may be stored back to the logical address table 133 in relation to the logical address, and the logical address may be flagged as valid in the table. If a fault occurs during translation, a record of the fault may be saved to the VMCS 125 as previously discussed. Translation of this list of logical addresses (for which address data is stored in the logical address table 133) may continue without exiting back to the VMM 130 (except perhaps in the case of detecting a fault). This alternative embodiment may thus allow for bulk translation of multiple logical addresses in hardware, without executing guest virtual instructions, and further speeding up the TOE process. This alternative embodiment will be discussed in more detail with reference to FIGS. 6A and 6B, below.

FIGS. 5A and 5B are a flow diagram of a method 500 of translating a logical address on virtual machine entry, according to an embodiment of the present disclosure. The method 500 may be performed by a system that may include hardware (e.g., circuitry, dedicated logic, and/or programmable logic), software (e.g., instructions executable on a computer system to perform hardware simulation), or a combination thereof. In an illustrative example, the method 500 may be performed by the system hardware 102 of the computing device 100 of FIGS. 1-2 or by the processor 106 of FIGS. 1-2. In one embodiment, the system hardware 102 execute the virtual machine monitor (VMM) 130 to perform aspects of the method 500 while the virtualization support circuitry 152 (and other invoked circuitry) of the processor 106 may perform other aspects of the method 500.

More specifically, referring to FIG. 5A, the method 500 may start with the VMM setting a bit flag of the TOE control field of the virtual machine control structure (VMCS) 125 associated with a virtual machine (502). The method 500 may continue with the VMM also storing a logical address (corresponding to an instruction to be emulated) into a set of VM entry control fields of the VMCS, where the logical address may include a segment selector and an offset (504). The method 500 may continue with the VMM invoking either a VMRESUME or a VMLAUNCH instruction to trigger entry into the virtual machine (506).

In response, the method 500 may continue with the processor receiving a VM entry instruction (508). The method 500 may continue with the processor loading a processor state from the VMCS 125 to establish a guest register state (510). The method 500 may continue with the processor determining whether the VMM has received a translate-on-entry (TOE) request (512). If no, the VMM may fetch and execute instructions of the virtual machine (516). If yes, then this is an indicator, to the processor, that the VMM is requesting a translate on entry and has thus stored a logical address into a set of VM entry control fields of the VMCS to be emulated.

With further reference to FIG. 5A, the method 500 may continue with the virtualization support circuitry 152 translating, e.g., by invoking address generation circuitry 158, the logical address to a guest virtual address (GVA) (528). The method 500 may continue with the virtualization support circuitry determining whether an address generation or segmentation fault has been detected (532). If yes, the method 500 may continue with the virtualization support circuitry storing fault information in the VMCS (560), loading the VMM state from the VMCS (564) and exiting to the VMM (568). If no, the method 500 may continue with the virtualization support circuitry invalidating, in the TLB 182, a TLB entry of the GVA tagged with address space identifier (ASID) of this virtual machine (536).

The method 500 may continue with translating, e.g., by invoking address translation circuitry 160, the GVA to a guest physical address (GPA) and the GPA to a host physical address (HPA) (540). The method 500 may continue with the virtualization support circuitry determining whether a page fault is detected during the translations (544). If yes, method 500 may continue with the virtualization support circuitry storing fault information in the VMCS (560), loading the VMM state from the VMCS (564) and exiting to the VMM (568). If no, the method may continue with the virtualization support circuitry testing access rights with respect to pages in memory corresponding to the GPA and the HPA (548). The method 500 may continue with determining whether a permission fault is detected based on the access rights testing (552). If yes, the method may continue with the virtualization support circuitry storing fault information in the VMCS (560), loading the VMM state from the VMCS (564) and exiting to the VMM (568). If no, the method 500 may continue with the virtualization support circuitry storing the translation result (GPA and HPA) in the VMCS 125 (556). The method 500 may continue with the virtualization support circuitry loading the VMM state from the VMCS (564) and exiting to the VMM (568).

In one embodiment, records of the various faults discussed above in blocks 532, 544, and 552 may be stored by way of storing an error code such as #PF (page fault) error code, for example. Any EPT violations or misconfigured EPT entries detected during translation may result in EPT violation or EPT misconfiguration VM exit. Upon exit, the virtualization support circuitry may also store, in the VM-exit information area 260 of the VMCS 125, a reason for the exit as the particular fault detected.

With further reference to FIG. 5B, the method 500 may continue with the VMM examining the VMCS 125 for a record of a fault stored in relation to a logical address (572). If no fault is found, the VMM may retrieve the GPA and/or HPA and the memory type from the TOE translation result area 265 of the VMCS for use in instruction emulation (580). If a fault is found, the VMM may process the fault or notify the virtual machine 140 of the fault for handling by a fault handler (584).

FIGS. 6A and 6B are a flow diagram of a method 600 of translating a logical address on virtual machine entry, according to another embodiment of the present disclosure. The method 600 may be performed by a system that may include hardware (e.g., circuitry, dedicated logic, and/or programmable logic), software (e.g., instructions executable on a computer system to perform hardware simulation), or a combination thereof. In an illustrative example, the method 600 may be performed by the system hardware 102 of the computing device 100 of FIGS. 1-2 or by the processor 106 of FIGS. 1-2. In one embodiment, the system hardware 102 execute the virtual machine monitor (VMM) 130 to perform aspects of the method 600 while the virtualization support circuitry 152 (and other invoked circuitry) of the processor 106 may perform other aspects of the method 600.

More specifically, referring to FIG. 6A, the method 600 may start with the VMM setting a bit flag of the TOE control field of the virtual machine control structure (VMCS) 125 associated with a virtual machine (602). The method 600 may continue with the VMM populating a table with address data of a plurality of logical addresses to be translated (604). The method 600 may continue with storing an address of a memory location of the table into the VMCS, so that the virtualization support circuitry 152 knows where to access the table in memory to retrieve the logical addresses (605). The method 600 may continue with the VMM invoking either a VMRESUME or a VMLAUNCH instruction to trigger entry into the virtual machine (506).

The method 600 may continue with the processor receiving a VM entry instruction (608). The method 600 may continue with the processor loading a processor state from the VMCS 125 to establish a guest register state (610). The method 600 may continue with the processor determining whether the VMM has requested a translate-on-entry (TOE) request (612). If no, the processor may fetch and execute instructions of the virtual machine (616).

With further reference to FIG. 6A, if yes, the method 600 may continue with determining whether another logical address is left in the table to translate (634). If no, the method 600 may continue with the virtualization support circuitry loading the VMM state from the VMCS (670) and exiting to the VMM (674). If yes, the method 600 may continue with the virtualization support circuitry translating, e.g., through invoking the address generation circuitry 158, the logical address to a guest virtual address (GVA) (638). The method 600 may continue with the virtualization support circuitry determining whether an address generation or a segmentation fault is detected (642). If yes, the virtualization support circuitry may store the fault information in the VMCS in relation to the logical address (666), load the VMM state from the VMCS (670) and exit to the VMM (674). If no, the method 600 may continue with the virtualization support circuitry invalidating a TLB entry of the GVA tagged with the address space identifier (ASID) of the virtual machine in the TLB 182 (646).

The method 600 may continue with the virtualization support circuitry translating, e.g., through invoking the translation circuitry 160, the GVA to a guest physical address (GPA) and the GPA to a host physical address (HPA) (650). The method 600 may continue with the virtualization support circuitry determining whether a page fault is detected (654). If yes, the virtualization support circuitry may store the fault information in the VMCS in relation to the logical address (666), load the VMM state from the VMCS (670) and exit to the VMM (674). If no, the method 600 may continue with the virtualization support circuitry testing access rights to pages in memory corresponding to the GPA and the HPA (658). The method 600 may continue with the virtualization support circuitry determining whether a permission fault was detected (662). If yes, the virtualization support circuitry may store the fault information in the VMCS in relation to the logical address (666), load the VMM state from the VMCS (670) and exit to the VMM (674). If no, the method 600 may continue with the virtualization support circuitry storing the translation result of the GPA and HPA (and memory type) in the table in relation to corresponding logical address (664), and marking the logical address as valid (668). In this way, the virtualization support circuitry may track which logical addresses have been successfully translated as the list of logical addresses are translated in turn. The method 600, therefore, may continue back to block 634 to continue translating a next logical address in the table.

In one embodiment, the various faults discussed above in blocks 642, 654, and 662 may be stored by way of storing an error code such as #PF (page fault) error code, for example. Any EPT violations or misconfigured EPT entries detected during translation may result in EPT violation or EPT misconfiguration VM exit. Upon exit, the virtualization support circuitry may also store, in the VM-exit information area 260 of the VMCS 125, a reason for the exit as the particular fault detected.

With further reference to FIG. 6B, the method 600 may continue with the VMM determining whether a fault-based exit occurred, e.g., by reading the VM-exit information area 260 of the VMCS 125 for reasons for the exit to the VMM (676). If no, the method 600 may continue with the VMM retrieving a plurality of GPAs or a plurality of HPAs, and corresponding memory type(s), from the table for performing instruction emulation (678). If yes, the method 600 may continue with the VMM processing the fault or notifying the virtual machine 140 of the fault for handling by the fault handler 145 (680). The VMM may also move, from the table to the VMCS, a subset of the logical addresses indicated as valid along with corresponding GPAs and HPAs (684). The method 600 may continue with the VMM removing, from the table, the logical addresses for which a fault resulted (688). The method 600 may continue with the VMM requesting the virtualization support circuitry to resume translation of the remainder of the logical addresses left in the table, e.g., by looping back to block 606 to resume translations (692).

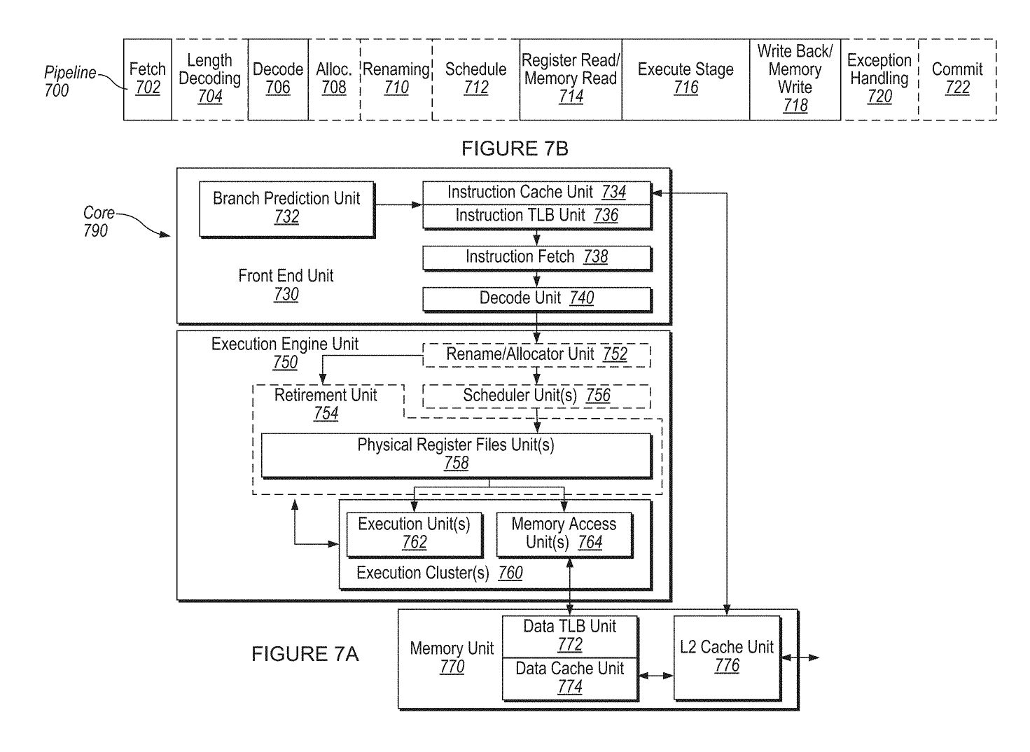

FIG. 7A is a block diagram illustrating a micro-architecture for a processor 700 that is used in translating a logical address on virtual machine entry. Specifically, processor 700 depicts an in-order architecture core and a register renaming logic, out-of-order issue/execution logic to be included in a processor according to at least one embodiment of the disclosure. The embodiments of translation on entry to a virtual machine can be implemented in the processor 700.

Processor 700 includes a front end unit 730 coupled to an execution engine unit 750, and both are coupled to a memory unit 770. The processor 700 may include a reduced instruction set computing (RISC) core, a complex instruction set computing (CISC) core, a very long instruction word (VLIW) core, or a hybrid or alternative core type. As yet another option, processor 700 may include a special-purpose core, such as, for example, a network or communication core, compression engine, graphics core, or the like. In one embodiment, processor 700 may be a multi-core processor or may be part of a multi-processor system.

The front end unit 730 includes a branch prediction unit 732 coupled to an instruction cache unit 734, which is coupled to an instruction translation lookaside buffer (TLB) 736, which is coupled to an instruction fetch unit 738, which is coupled to a decode unit 740. The decode unit 740 (also known as a decoder) may decode instructions, and generate as an output one or more micro-operations, micro-code entry points, microinstructions, other instructions, or other control signals, which are decoded from, or which otherwise reflect, or are derived from, the original instructions. The decoder 740 may be implemented using various different mechanisms. Examples of suitable mechanisms include, but are not limited to, look-up tables, hardware implementations, programmable logic arrays (PLAs), microcode read only memories (ROMs), etc. The instruction cache unit 734 is further coupled to the memory unit 770. The decode unit 740 is coupled to a rename/allocator unit 752 in the execution engine unit 750.

The execution engine unit 750 includes the rename/allocator unit 752 coupled to a retirement unit 754 and a set of one or more scheduler unit(s) 756. The scheduler unit(s) 756 represents any number of different schedulers, including reservations stations (RS), central instruction window, etc. The scheduler unit(s) 756 is coupled to the physical register file(s) unit(s) 758. Each of the physical register file(s) units 758 represents one or more physical register files, different ones of which store one or more different data types, such as scalar integer, scalar floating point, packed integer, packed floating point, vector integer, vector floating point, etc., status (e.g., an instruction pointer that is the address of the next instruction to be executed), etc. The physical register file(s) unit(s) 758 is overlapped by the retirement unit 754 to illustrate various ways in which register renaming and out-of-order execution may be implemented (e.g., using a reorder buffer(s) and a retirement register file(s), using a future file(s), a history buffer(s), and a retirement register file(s); using a register maps and a pool of registers; etc.).

Generally, the architectural registers are visible from the outside of the processor or from a programmer's perspective. The registers are not limited to any known particular type of circuit. Various different types of registers are suitable as long as they are capable of storing and providing data as described herein. Examples of suitable registers include, but are not limited to, dedicated physical registers, dynamically allocated physical registers using register renaming, combinations of dedicated and dynamically allocated physical registers, etc. The retirement unit 754 and the physical register file(s) unit(s) 758 are coupled to the execution cluster(s) 760. The execution cluster(s) 760 includes a set of one or more execution units 762 and a set of one or more memory access units 764. The execution units 762 may perform various operations (e.g., shifts, addition, subtraction, multiplication) and operate on various types of data (e.g., scalar floating point, packed integer, packed floating point, vector integer, vector floating point).

While some embodiments may include a number of execution units dedicated to specific functions or sets of functions, other embodiments may include only one execution unit or multiple execution units that all perform all functions. The scheduler unit(s) 756, physical register file(s) unit(s) 758, and execution cluster(s) 760 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 764). It should also be understood that where separate pipelines are used, one or more of these pipelines may be out-of-order issue/execution and the rest in-order.

The set of memory access units 764 is coupled to the memory unit 770, which may include a data prefetcher 780, a data TLB unit 772, a data cache unit (DCU) 774, and a level 2 (L2) cache unit 776, to name a few examples. In some embodiments DCU 774 is also known as a first level data cache (L1 cache). The DCU 774 may handle multiple outstanding cache misses and continue to service incoming stores and loads. It also supports maintaining cache coherency. The data TLB unit 772 is a cache used to improve virtual address translation speed by mapping virtual and physical address spaces. In one exemplary embodiment, the memory access units 764 may include a load unit, a store address unit, and a store data unit, each of which is coupled to the data TLB unit 772 in the memory unit 770. The L2 cache unit 776 may be coupled to one or more other levels of cache and eventually to a main memory.

In one embodiment, the data prefetcher 780 speculatively loads/prefetches data to the DCU 774 by automatically predicting which data a program is about to consume. Prefetching may refer to transferring data stored in one memory location (e.g., position) of a memory hierarchy (e.g., lower level caches or memory) to a higher-level memory location that is closer (e.g., yields lower access latency) to the processor before the data is actually demanded by the processor. More specifically, prefetching may refer to the early retrieval of data from one of the lower level caches/memory to a data cache and/or prefetch buffer before the processor issues a demand for the specific data being returned.

The processor 700 may support one or more instructions sets (e.g., the x86 instruction set (with some extensions that have been added with newer versions); the MIPS instruction set of Imagination Technologies of Kings Langley, Hertfordshire, UK; the ARM instruction set (with optional additional extensions such as NEON) of ARM Holdings of Sunnyvale, Calif.).

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes a separate instruction and data cache units and a shared L2 cache unit, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor. Note that instruction cache unit 734, data cache unit 774, and L2 cache unit 776 would not generally implement the process described in this disclosure, as generally these cache units use on-die memory that does not exhibit page-locality behavior.

FIG. 7B is a block diagram illustrating an in-order pipeline and a register renaming stage, out-of-order issue/execution pipeline implemented by processor 700 of FIG. 7A according to some embodiments of the disclosure. The solid lined boxes in FIG. 7B illustrate an in-order pipeline, while the dashed lined boxes illustrates a register renaming, out-of-order issue/execution pipeline. In FIG. 7B, a processor pipeline 700 includes a fetch stage 702, a length decode stage 704, a decode stage 706, an allocation stage 708, a renaming stage 710, a scheduling (also known as a dispatch or issue) stage 712, a register read/memory read stage 714, an execute stage 716, a write back/memory write stage 718, an exception handling stage 722, and a commit stage 724. In some embodiments, the ordering of stages 702-724 may be different than illustrated and are not limited to the specific ordering shown in FIG. 7B.

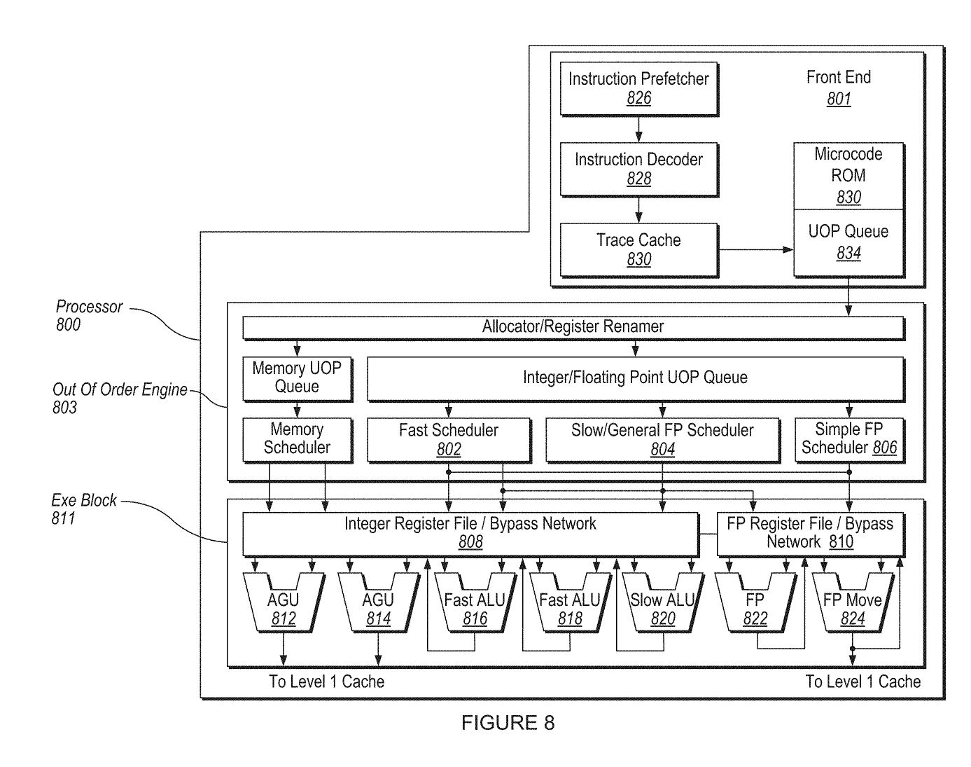

FIG. 8 illustrates a block diagram of the micro-architecture for a processor 800 that includes logic circuits that may be used to perform translation on entry to a virtual machine, according to one embodiment. In some embodiments, an instruction in accordance with one embodiment can be implemented to operate on data elements having sizes of byte, word, doubleword, quadword, etc., as well as datatypes, such as single and double precision integer and floating point datatypes. In one embodiment the in-order front end 801 is the part of the processor 800 that fetches instructions to be executed and prepares them to be used later in the processor pipeline. The embodiments of the page additions and content copying can be implemented in processor 800.

The front end 801 may include several units. In one embodiment, the instruction prefetcher 816 fetches instructions from memory and feeds them to an instruction decoder 818 which in turn decodes or interprets them. For example, in one embodiment, the decoder decodes a received instruction into one or more operations called “micro-instructions” or “micro-operations” (also called micro op or uops) that the machine can execute. In other embodiments, the decoder parses the instruction into an opcode and corresponding data and control fields that are used by the micro-architecture to perform operations in accordance with one embodiment. In one embodiment, the trace cache 830 takes decoded uops and assembles them into program ordered sequences or traces in the uop queue 834 for execution. When the trace cache 830 encounters a complex instruction, microcode ROM (or RAM) 832 provides the uops needed to complete the operation.

Some instructions are converted into a single micro-op, whereas others need several micro-ops to complete the full operation. In one embodiment, if more than four micro-ops are needed to complete an instruction, the decoder 818 accesses the microcode ROM 832 to do the instruction. For one embodiment, an instruction can be decoded into a small number of micro ops for processing at the instruction decoder 818. In another embodiment, an instruction can be stored within the microcode ROM 832 should a number of micro-ops be needed to accomplish the operation. The trace cache 830 refers to an entry point programmable logic array (PLA) to determine a correct micro-instruction pointer for reading the micro-code sequences to complete one or more instructions in accordance with one embodiment from the micro-code ROM 832. After the microcode ROM 832 finishes sequencing micro-ops for an instruction, the front end 801 of the machine resumes fetching micro-ops from the trace cache 830.

The out-of-order execution engine 803 is where the instructions are prepared for execution. The out-of-order execution logic has a number of buffers to smooth out and re-order the flow of instructions to optimize performance as they go down the pipeline and get scheduled for execution. The allocator logic allocates the machine buffers and resources that each uop needs in order to execute. The register renaming logic renames logic registers onto entries in a register file. The allocator also allocates an entry for each uop in one of the two uop queues, one for memory operations and one for non-memory operations, in front of the instruction schedulers: memory scheduler, fast scheduler 802, slow/general floating point scheduler 804, and simple floating point scheduler 806. The uop schedulers 802, 804, 806, determine when a uop is ready to execute based on the readiness of their dependent input register operand sources and the availability of the execution resources the uops need to complete their operation. The fast scheduler 802 of one embodiment can schedule on each half of the main clock cycle while the other schedulers can only schedule once per main processor clock cycle. The schedulers arbitrate for the dispatch ports to schedule uops for execution.

Register files 808, 810, sit between the schedulers 802, 804, 806, and the execution units 812, 814, 816, 818, 820, 822, 824 in the execution block 811. There is a separate register file 808, 810, for integer and floating point operations, respectively. Each register file 808, 810, of one embodiment also includes a bypass network that can bypass or forward just completed results that have not yet been written into the register file to new dependent uops. The integer register file 808 and the floating point register file 810 are also capable of communicating data with the other. For one embodiment, the integer register file 808 is split into two separate register files, one register file for the low order 32 bits of data and a second register file for the high order 32 bits of data. The floating point register file 810 of one embodiment has 128 bit wide entries because floating point instructions typically have operands from 64 to 128 bits in width.

The execution block 811 contains the execution units 812, 814, 816, 818, 820, 822, 824, where the instructions are actually executed. This section includes the register files 808, 810, that store the integer and floating point data operand values that the micro-instructions need to execute. The processor 800 of one embodiment is comprised of a number of execution units: address generation unit (AGU) 812, AGU 814, fast ALU 816, fast ALU 818, slow ALU 810, floating point ALU 812, floating point move unit 814. For one embodiment, the floating point execution blocks 812, 814, execute floating point, MMX, SIMD, and SSE, or other operations. The floating point ALU 812 of one embodiment includes a 64 bit by 64 bit floating point divider to execute divide, square root, and remainder micro-ops. For embodiments of the present disclosure, instructions involving a floating point value may be handled with the floating point hardware.

In one embodiment, the ALU operations go to the high-speed ALU execution units 816, 818. The fast ALUs 816, 818, of one embodiment can execute fast operations with an effective latency of half a clock cycle. For one embodiment, most complex integer operations go to the slow ALU 820 as the slow ALU 820 includes integer execution hardware for long latency type of operations, such as a multiplier, shifts, flag logic, and branch processing. Memory load/store operations are executed by the AGUs 822, 824. For one embodiment, the integer ALUs 816, 818, 820, are described in the context of performing integer operations on 64 bit data operands. In alternative embodiments, the ALUs 816, 818, 820, can be implemented to support a variety of data bits including 16, 32, 128, 256, etc. Similarly, the floating point units 822, 824, can be implemented to support a range of operands having bits of various widths. For one embodiment, the floating point units 822, 824, can operate on 128 bits wide packed data operands in conjunction with SIMD and multimedia instructions.

In one embodiment, the uops schedulers 802, 804, 806, dispatch dependent operations before the parent load has finished executing. As uops are speculatively scheduled and executed in processor 800, the processor 800 also includes logic to handle memory misses. If a data load misses in the data cache, there can be dependent operations in flight in the pipeline that have left the scheduler with temporarily incorrect data. A replay mechanism tracks and re-executes instructions that use incorrect data. Only the dependent operations need to be replayed and the independent ones are allowed to complete. The schedulers and replay mechanism of one embodiment of a processor are also designed to catch instruction sequences for text string comparison operations.

The term “registers” may refer to the on-board processor storage locations that are used as part of instructions to identify operands. In other words, registers may be those that are usable from the outside of the processor (from a programmer's perspective). However, the registers of an embodiment should not be limited in meaning to a particular type of circuit. Rather, a register of an embodiment is capable of storing and providing data, and performing the functions described herein. The registers described herein can be implemented by circuitry within a processor using any number of different techniques, such as dedicated physical registers, dynamically allocated physical registers using register renaming, combinations of dedicated and dynamically allocated physical registers, etc. In one embodiment, integer registers store thirty-two bit integer data. A register file of one embodiment also contains eight multimedia SIMD registers for packed data.

For the discussions herein, the registers are understood to be data registers designed to hold packed data, such as 64 bits wide MMX™ registers (also referred to as ‘mm’ registers in some instances) in microprocessors enabled with MMX technology from Intel Corporation of Santa Clara, Calif. These MMX registers, available in both integer and floating point forms, can operate with packed data elements that accompany SIMD and SSE instructions. Similarly, 128 bits wide XMM registers relating to SSE2, SSE3, SSE4, or beyond (referred to generically as “SSEx”) technology can also be used to hold such packed data operands. In one embodiment, in storing packed data and integer data, the registers do not need to differentiate between the two data types. In one embodiment, integer and floating point are either contained in the same register file or different register files. Furthermore, in one embodiment, floating point and integer data may be stored in different registers or the same registers.

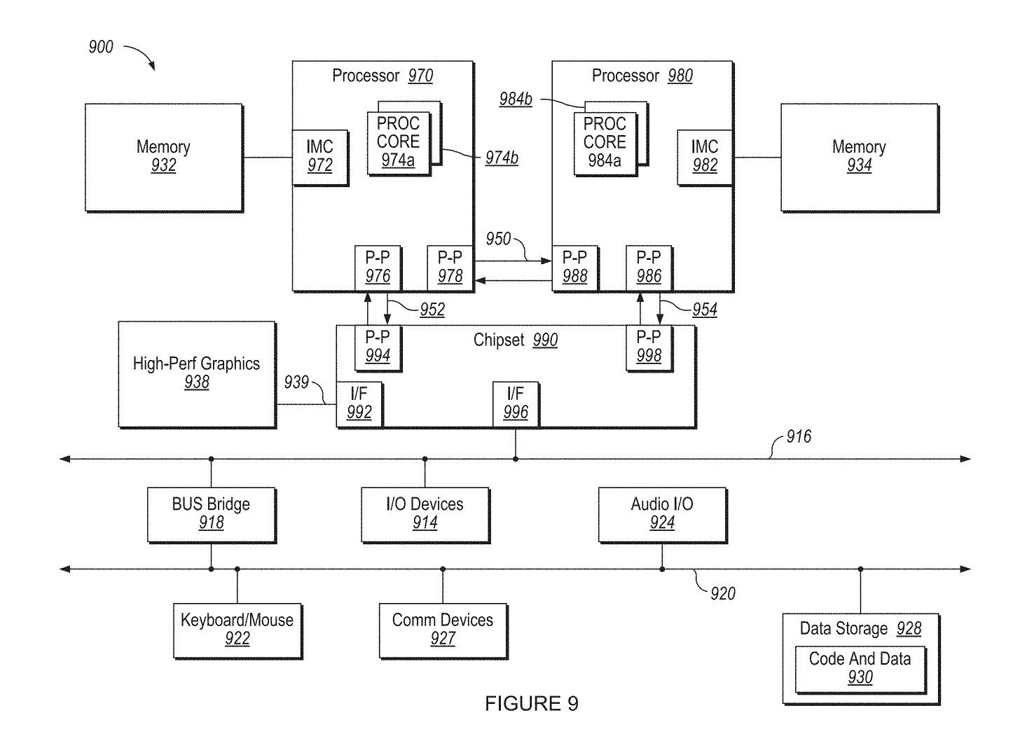

Embodiments may be implemented in many different system types. Referring now to FIG. 9, shown is a block diagram of a multiprocessor system 900 in accordance with an implementation. As shown in FIG. 9, multiprocessor system 900 is a point-to-point interconnect system, and includes a first processor 970 and a second processor 980 coupled via a point-to-point interconnect 950. As shown in FIG. 9, each of processors 970 and 980 may be multicore processors, including first and second processor cores (i.e., processor cores 974a and 974b and processor cores 984a and 984b), although potentially many more cores may be present in the processors.

While shown with two processors 970, 980, it is to be understood that the scope of the present disclosure is not so limited. In other implementations, one or more additional processors may be present in a given processor.

Processors 970 and 980 are shown including integrated memory controller units 972 and 982, respectively. Processor 970 also includes as part of its bus controller units point-to-point (P-P) interfaces 976 and 988; similarly, second processor 980 includes P-P interfaces 986 and 988. Processors 970, 980 may exchange information via a point-to-point (P-P) interface 950 using P-P interface circuits 978, 988. As shown in FIG. 9, IMCs 972 and 982 couple the processors to respective memories, namely a memory 932 and a memory 934, which may be portions of main memory locally attached to the respective processors.

Processors 970, 980 may each exchange information with a chipset 990 via individual P-P interfaces 952, 954 using point to point interface circuits 976, 994, 986, 998. Chipset 990 may also exchange information with a high-performance graphics circuit 938 via a high-performance graphics interface 939.

A shared cache (not shown) may be included in either processor or outside of both processors, yet connected with the processors via P-P interconnect, such that either or both processors' local cache information may be stored in the shared cache if a processor is placed into a low power mode. Page locality may also be created in the shared cache across one or more cache controllers when allocating entries to the shared cache.

Chipset 990 may be coupled to a first bus 916 via an interface 996. In one embodiment, first bus 916 may be a Peripheral Component Interconnect (PCI) bus, or a bus such as a PCI Express bus or interconnect bus, although the scope of the present disclosure is not so limited.

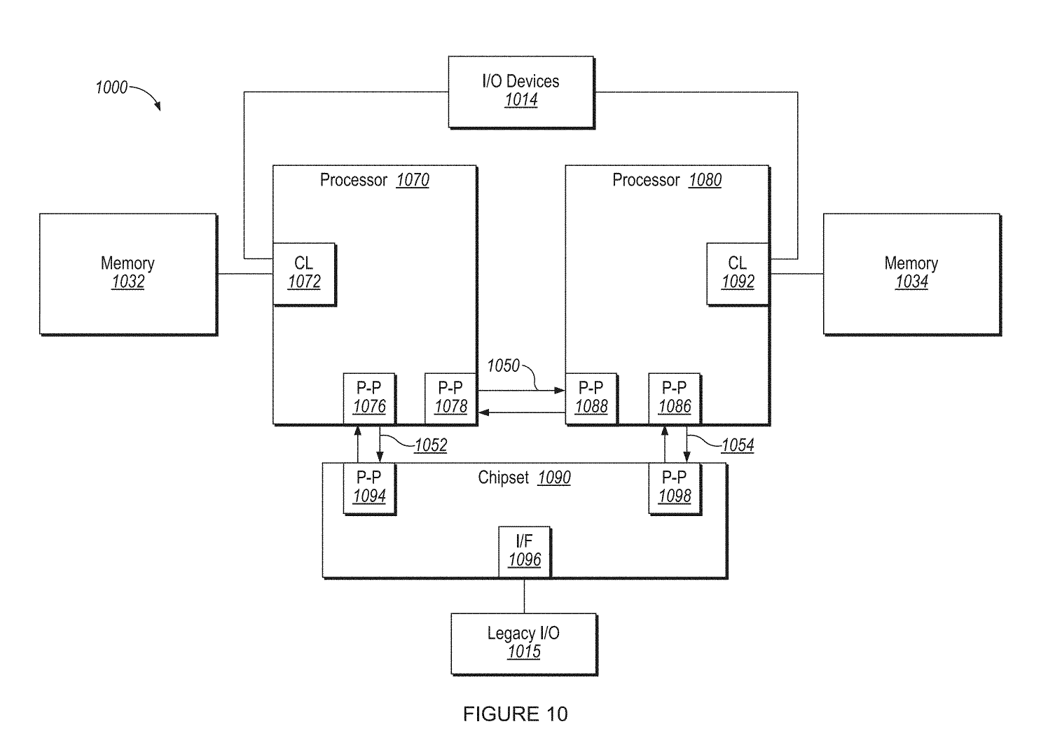

Referring now to FIG. 10, shown is a block diagram of a third system 1000 in accordance with an embodiment of the present disclosure. Like elements in FIGS. 9 and 10 bear like reference numerals, and certain aspects of FIG. 10 have been omitted from FIG. 9 in order to avoid obscuring other aspects of FIG. 10.

FIG. 10 illustrates that the processors 1070, 1080 may include integrated memory and I/O control logic (“CL”) 1072 and 1092, respectively. For at least one embodiment, the CL 1072, 1082 may include integrated memory controller units such as described herein. In addition. CL 1072, 1092 may also include I/O control logic. FIG. 10 illustrates that the memories 1032, 1034 are coupled to the CL 1072, 1092, and that I/O devices 1014 are also coupled to the control logic 1072, 1092. Legacy I/O devices 1015 are coupled to the chipset 1090.

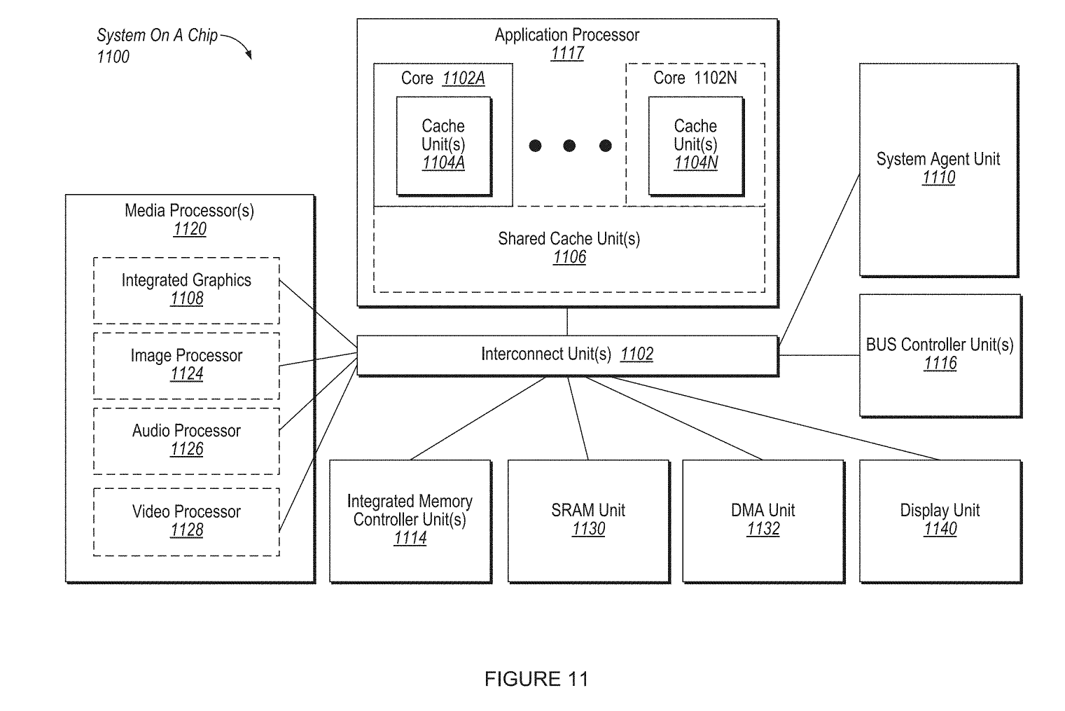

FIG. 11 is an exemplary system on a chip (SoC) 1100 that may include one or more of the cores 1102. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Within the exemplary SoC 1100 of FIG. 11, dashed lined boxes are features on more advanced SoCs. An interconnect unit(s) 1102 may be coupled to: an application processor 1117 which includes a set of one or more cores 1102A-N and shared cache unit(s) 1106; a system agent unit 1110; a bus controller unit(s) 1116; an integrated memory controller unit(s) 1114; a set or one or more media processors 1120 which may include integrated graphics logic 1108, an image processor 1124 for providing still and/or video camera functionality, an audio processor 1126 for providing hardware audio acceleration, and a video processor 1128 for providing video encode/decode acceleration; a static random access memory (SRAM) unit 1130; a direct memory access (DMA) unit 1132; and a display unit 1140 for coupling to one or more external displays.

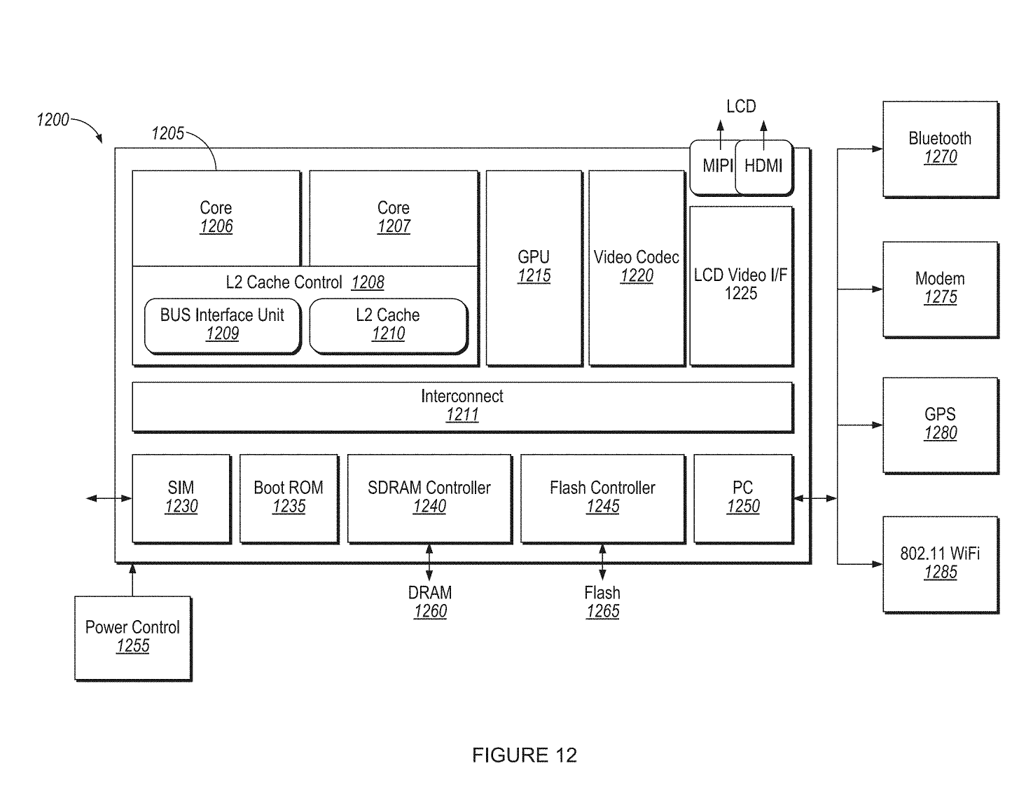

Turning next to FIG. 12, an embodiment of a system on-chip (SoC) design in accordance with embodiments of the disclosure is depicted. As an illustrative example, SoC 1200 is included in user equipment (UE). In one embodiment, UE refers to any device to be used by an end-user to communicate, such as a hand-held phone, smartphone, tablet, ultra-thin notebook, notebook with broadband adapter, or any other similar communication device. A UE may connect to a base station or node, which can correspond in nature to a mobile station (MS) in a GSM network. The embodiments of the page additions and content copying can be implemented in SoC 1200.

Here, SoC 1200 includes 2 cores—1206 and 1207. Similar to the discussion above, cores 1206 and 1207 may conform to an Instruction Set Architecture, such as a processor having the Intel® Architecture Core™, an Advanced Micro Devices, Inc. (AMD) processor, a MIPS-based processor, an ARM-based processor design, or a customer thereof, as well as their licensees or adopters. Cores 1206 and 1207 are coupled to cache control 1208 that is associated with bus interface unit 1209 and L2 cache 1210 to communicate with other parts of system 1200. Interconnect 1211 includes an on-chip interconnect, such as an IOSF, AMBA, or other interconnects discussed above, which can implement one or more aspects of the described disclosure.

In one embodiment, SDRAM controller 1240 may connect to interconnect 1211 via cache 125. Interconnect 1211 provides communication channels to the other components, such as a Subscriber Identity Module (SIM) 1230 to interface with a SIM card, a boot ROM 1235 to hold boot code for execution by cores 1206 and 1207 to initialize and boot SoC 1200, a SDRAM controller 1240 to interface with external memory (e.g. DRAM 1260), a flash controller 1245 to interface with non-volatile memory (e.g. Flash 1265), a peripheral control 1250 (e.g. Serial Peripheral Interface) to interface with peripherals, video codecs 1220 and Video interface 1225 to display and receive input (e.g. touch enabled input), GPU 1215 to perform graphics related computations, etc. Any of these interfaces may incorporate aspects of the embodiments described herein.

In addition, the system illustrates peripherals for communication, such as a Bluetooth® module 1270, 3G modem 1275, GPS 1280, and Wi-Fi® 1285. Note as stated above, a UE includes a radio for communication. As a result, these peripheral communication modules may not all be included. However, in a UE some form of a radio for external communication should be included.

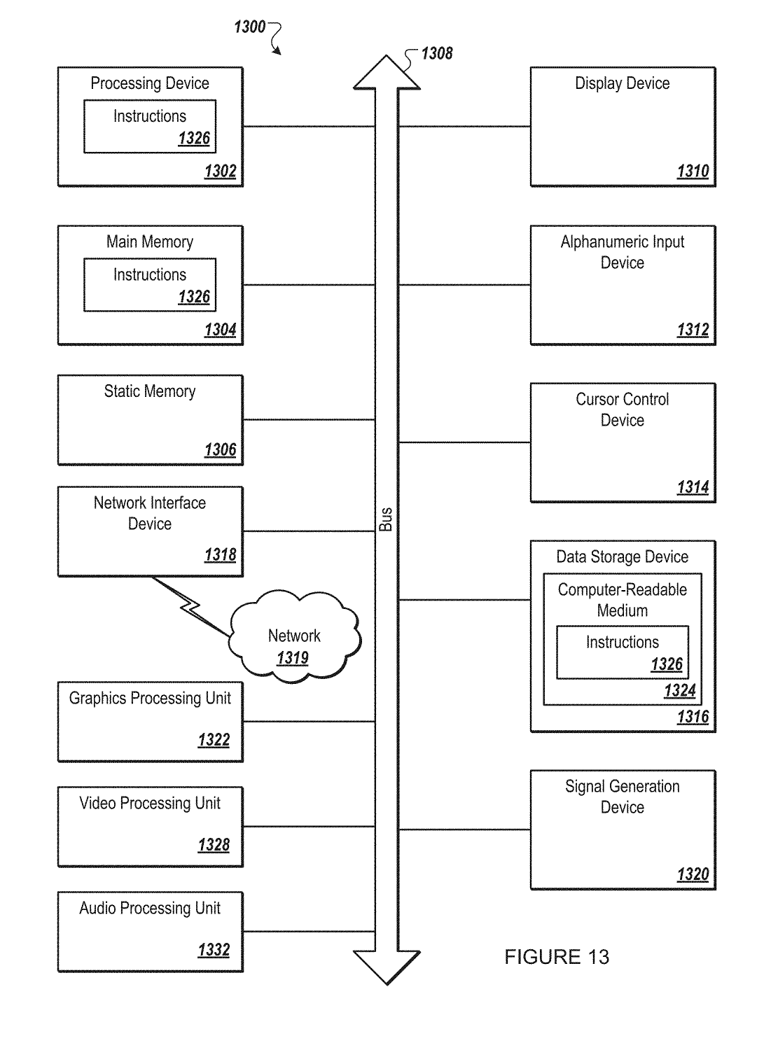

FIG. 13 illustrates a diagrammatic representation of a machine in the example form of a computing system 1300 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client device in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. The embodiments of the page additions and content copying can be implemented in computing system 1300.

The computing system 1300 includes a processing device 1302, main memory 1304 (e.g., flash memory, dynamic random access memory (DRAM) (such as synchronous DRAM (SDRAM) or DRAM (RDRAM), etc.), a static memory 1306 (e.g., flash memory, static random access memory (SRAM), etc.), and a data storage device 1318, which communicate with each other via a bus 1308. In one embodiment, the bus 1308 may be made up of the system bus 170-1 and/or the memory bus 170-2 of FIG. 1, and the memory and peripheral devices sharing the bus 1308 may be or work through the system agent 114 similar to as discussed with reference to FIG. 1.

Processing device 1302 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 1302 may also be one or more special-purpose processing devices such as an application specific integrated circuit (ASIC), a field programmable gate array (FPGA), a digital signal processor (DSP), network processor, or the like. In one embodiment, processing device 1302 may include one or processor cores. The processing device 1302 is configured to execute the processing logic 1326 for performing the operations discussed herein.

In one embodiment, processing device 1302 can be part of the computing system 100 of FIG. 1. Alternatively, the computing system 1300 can include other components as described herein. It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

The computing system 1300 may further include a network interface device 1318 communicably coupled to a network 1319. The computing system 1300 also may include a video display device 1310 (e.g., a liquid crystal display (LCD) or a cathode ray tube (CRT)), an alphanumeric input device 1310 (e.g., a keyboard), a cursor control device 1314 (e.g., a mouse), a signal generation device 1320 (e.g., a speaker), or other peripheral devices. Furthermore, computing system 1300 may include a graphics processing unit 1322, a video processing unit 1328 and an audio processing unit 1332. In another embodiment, the computing system 1300 may include a chipset (not illustrated), which refers to a group of integrated circuits, or chips, that are designed to work with the processing device 1302 and controls communications between the processing device 1302 and external devices. For example, the chipset may be a set of chips on a motherboard that links the processing device 1302 to very high-speed devices, such as main memory 1304 and graphic controllers, as well as linking the processing device 1302 to lower-speed peripheral buses of peripherals, such as USB, PCI or ISA buses.

The data storage device 1318 may include a computer-readable storage medium 1324 on which is stored software 1326 embodying any one or more of the methodologies of functions described herein. The software 1326 may also reside, completely or at least partially, within the main memory 1304 as instructions 1326 and/or within the processing device 1302 as processing logic during execution thereof by the computing system 1300; the main memory 1304 and the processing device 1302 also constituting computer-readable storage media.

The computer-readable storage medium 1324 may also be used to store instructions 1326 utilizing the processing device 1302, such as described with respect to FIGS. 1 and 2, and/or a software library containing methods that call the above applications. While the computer-readable storage medium 1324 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instruction for execution by the machine and that cause the machine to perform any one or more of the methodologies of the present embodiments. The term “computer-readable storage medium” shall accordingly be taken to include, but not be limited to, solid-state memories, and optical and magnetic media.

The following examples pertain to further embodiments.

Example 1 is a processor comprising a core including virtualization support circuitry to: a) retrieve a logical address from a virtual machine control structure (VMCS) associated with a virtual machine, the logical address corresponding to an instruction to be accessed; b) translate the logical address to a guest virtual address; c) invoke translation circuitry to translate the guest virtual address to a guest physical address, and translate the guest physical address to a host physical address; and d) store at least one of the guest physical address or the host physical address in the VMCS.

In Example 2, the processor of Example 1, wherein the virtualization support circuitry is further to detect that a bit flag is set within a translate-on-entry control field of the VMCS as a trigger to perform the retrieve, the translate, the invoke, and the store; and wherein the core is to further to a) execute a virtual machine monitor (VMM) to, responsive to a request, which calls for access to the instruction, to translate the logical address to the host physical address: b) store the logical address in the VMCS associated with the virtual machine; and c) retrieve, from the VMCS, the at least one of the guest physical address or the host physical address for emulating the instruction for the virtual machine.

In Example 3, the processor of Example 2, wherein the virtualization support circuitry is further to: a) invoke address generation circuitry of the core to translate the logical address to the guest virtual address; b) detect one of an address generation fault or a segmentation fault; c) store, in the VMCS, a record of the address generation fault or the segmentation fault in relation to the logical address; and d) perform a fault-based exit to the VMM.

In Example 4, the processor of Example 2, wherein the virtualization support circuitry is further to test access rights to memory pages corresponding to the guest physical address and the host physical address, and wherein the core is further to cause the virtualization support circuitry to: a) detect a fault as a result of translation of the guest virtual address to the host physical address; b) store, in the VMCS, a record of the fault in relation to the logical address; and c) perform a fault-based exit to the VMM.

In Example 5, the processor of Example 2, wherein the VMM is further to: a) examine the VMCS for a record of a fault stored in relation to the logical address; and b) responsive to finding a record of the fault, one of process the fault or notify the virtual machine of the fault.

In Example 6, the processor of Example 2, wherein the virtualization support circuitry is further to: a) test access rights to memory pages corresponding to the guest physical address and the host physical address; b) load a VMM state from the VMCS; and c) perform an exit to the VMM, with a reason for the exit comprising a translate-on-entry exit.

In Example 7, the processor of Example 2, wherein the VMM is to emulate the instruction to direct a hardware device on behalf of the virtual machine.

In Example 8, the processor of Example 1, wherein the translation circuitry comprises a page miss handler (PMH) circuit.

In Example 9, the processor of Example 1, wherein the virtualization support circuitry comprises the core executing a microcode.

In Example 10, the processor of Example 1, wherein the core is further to store the guest virtual address in a translation lookaside buffer entry associated with a current address space identifier for the virtual machine.

In Example 11, the processor of Example 10, wherein the virtualization support circuitry is further to invalidate the translation lookaside buffer entry in response to translation of the logical address to the guest virtual address.

Various embodiments may have different combinations of the structural features described above. For instance, all optional features of the computing system described above may also be implemented with respect to the method or process described herein and specifics in the examples may be used anywhere in one or more embodiments.

Example 12 is a system comprising: 1) a memory to store a virtual machine storage structure (VMCS) associated with a virtual machine (VM) and to store a table in which to populate a plurality of logical addresses corresponding instructions to be emulated for the virtual machine; and 2) a processor operatively coupled to the memory, wherein the processor includes virtualization support circuitry to: a) detect that a bit flag is set within a translate-on-entry control field of the VMCS associated with the virtual machine; and b) responsive to detecting the bit flag, for each of at least some of the plurality of logical addresses: c) retrieve a logical address from the table; d) translate the logical address to a guest virtual address; d) invoke a translation circuitry to translate the guest virtual address to a guest physical address and to translate the guest physical address to a host physical address; and e) store at least one of the guest physical address or the host physical address in the table in relation to the logical address.

In Example 13, the system of claim 12, wherein the processor is further to a) execute a virtual machine monitor (VMM) to, responsive to a requirement to translate the plurality of logical addresses to a plurality of host physical addresses: b) populate the table with the plurality of logical addresses; and c) retrieve, from the table, one of a plurality of guest physical addresses or the plurality of host physical addresses for emulating the instructions for the virtual machine.

In Example 14, the system of claim 13, wherein the VMM is further to store, in the VMCS, an address of a location of the table in the memory, and wherein the virtualization support circuitry is further to access the table at the location in memory to retrieve the logical address.

In Example 15, the system of claim 13, wherein the virtualization support circuitry is further to: a) invoke address generation circuitry of the processor to translate the logical address to the guest physical address; b) detect one of an address generation fault or a segmentation fault; c) store, in the VMCS, a record of the address generation fault or the segmentation fault in relation to the logical address; and d) perform a fault-based exit to the VMM.

In Example 16, the system of claim 13, wherein the virtualization support circuitry is further to: a) test access rights to memory pages corresponding to the guest physical address and the host physical address; b) detect a permission fault as a result of testing the access rights; c) store, in the VMCS, a record of the permission fault in relation to the logical address; and d) perform a fault-based exit to the VMM.

In Example 17, the system of claim 13, wherein the virtualization support circuitry is further to: a) indicate the logical address as valid in the table; b) responsive to translating a second logical address of the plurality of logical addresses to second guest virtual address, detect a fault as a result of translating the second guest virtual address to a second host physical address; c) store, in the VMCS, the fault in relation to the second logical address; and d) perform a fault-based exit to the VMM.

In Example 18, the system of claim 17, wherein the VMM is further to, responsive to the fault-based exit: a) move, from the table to the VMCS, a subset of the plurality of logical addresses indicated as valid in the table along with corresponding guest physical addresses and host physical addresses; b) remove, from the table, the second logical address for which the fault resulted; and c) request the virtualization support circuitry to resume translation of a subset of the plurality of logical addresses that remains in the table.

Various embodiments may have different combinations of the structural features described above. For instance, all optional features of the processors and methods described above may also be implemented with respect to a system described herein and specifics in the examples may be used anywhere in one or more embodiments.

Example 19 is a system comprising: a) retrieving, by virtualization support circuitry of a processor, a logical address from a virtual machine control structure (VMCS) associated with a virtual machine, the logical address corresponding to an instruction to be accessed; b) translating, by the virtualization support circuitry, the logical address to a guest virtual address; c) invoking, by the virtualization support circuitry, translation circuitry to: translate the guest virtual address to a guest physical address, and translate the guest physical address to a host physical address; and d) storing, by the virtualization support circuitry, at least one of the guest physical address or the host physical address in the VMCS.

In Example 20, the method of claim 19, further comprising: a) detecting, by the virtualization support circuitry, that a bit flag is set within a translate-on-entry control field of the VMCS as a trigger to perform the retrieving, the translating, the invoking, and the storing; b) retrieving, by the virtualization support circuitry, the logical address from a plurality of VM entry control fields of the VMCS; and c) translating, by invoking address generation circuitry of the processor, the logical address to the guest virtual address.

In Example 21, the method of claim 19, further comprising: a) receiving, by a virtual machine monitor (VMM) executed by the processor, a virtual machine entry instruction for a virtual machine (VM); b) responsive to execution of the virtual machine entry instruction, storing, by the VMM, the logical address in the VMCS associated with the virtual machine; and c) retrieving, by the VMM from the VMCS, the at least one of the guest physical address or the host physical address for emulating the instruction for the virtual machine.

In Example 22, the method of claim 21, further comprising: a) detecting one of an address generation fault or a segmentation fault; b) storing, in the VMCS, a record of the address generation fault or the segmentation fault in relation to the logical address; and c) performing a fault-based exit to the VMM.

In Example 23, the method of claim 21, further comprising: a) testing access rights to memory pages corresponding to the guest physical address and the host physical address; b) detecting a permission fault as a result of testing the access rights; c) storing, in the VMCS, a record of the permission fault in relation to the logical address; and d) performing a fault-based exit to the VMM.

In Example 24, the method of claim 21, further comprising: a) examining, by the VMM, the VMCS for a record of a fault stored in relation to the logical address; and b) responsive to finding the record of a fault, one of processing the fault or notifying the virtual machine of the fault.

In Example 25, the method of claim 21, further comprising: a) loading, by the virtualization support circuitry, a VMM state from the VMCS; and b) performing an exit to the VMM, with a reason for the exit comprising a translate-on-entry exit.

Various embodiments may have different combinations of the structural features described above. For instance, all optional features of the processors and methods described above may also be implemented with respect to a system described herein and specifics in the examples may be used anywhere in one or more embodiments.

While the present disclosure has been described with respect to a limited number of embodiments, those skilled in the art will appreciate numerous modifications and variations therefrom. It is intended that the appended claims cover all such modifications and variations as fall within the true spirit and scope of this present disclosure.

In the description herein, numerous specific details are set forth, such as examples of specific types of processors and system configurations, specific hardware structures, specific architectural and micro architectural details, specific register configurations, specific instruction types, specific system components, specific measurements/heights, specific processor pipeline stages and operation etc. in order to provide a thorough understanding of the present disclosure. It will be apparent, however, to one skilled in the art that these specific details need not be employed to practice the present disclosure. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of computer system have not been described in detail in order to avoid unnecessarily obscuring the present disclosure.

The embodiments are described with reference to determining validity of data in cache lines of a sector-based cache in specific integrated circuits, such as in computing platforms or microprocessors. The embodiments may also be applicable to other types of integrated circuits and programmable logic devices. For example, the disclosed embodiments are not limited to desktop computer systems or portable computers, such as the Intel® Ultrabooks™ computers. And may be also used in other devices, such as handheld devices, tablets, other thin notebooks, systems on a chip (SoC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below. It is described that the system can be any kind of computer or embedded system. The disclosed embodiments may especially be used for low-end devices, like wearable devices (e.g., watches), electronic implants, sensory and control infrastructure devices, controllers, supervisory control and data acquisition (SCADA) systems, or the like. Moreover, the apparatuses, methods, and systems described herein are not limited to physical computing devices, but may also relate to software optimizations for energy conservation and efficiency. As will become readily apparent in the description below, the embodiments of methods, apparatuses, and systems described herein (whether in reference to hardware, firmware, software, or a combination thereof) are vital to a ‘green technology’ future balanced with performance considerations.

Although the embodiments herein are described with reference to a processor, other embodiments are applicable to other types of integrated circuits and logic devices. Similar techniques and teachings of embodiments of the present disclosure can be applied to other types of circuits or semiconductor devices that can benefit from higher pipeline throughput and improved performance. The teachings of embodiments of the present disclosure are applicable to any processor or machine that performs data manipulations. However, the present disclosure is not limited to processors or machines that perform 512 bit, 256 bit, 128 bit, 64 bit, 32 bit, or 16 bit data operations and can be applied to any processor and machine in which manipulation or management of data is performed. In addition, the description herein provides examples, and the accompanying drawings show various examples for the purposes of illustration. However, these examples should not be construed in a limiting sense as they are merely intended to provide examples of embodiments of the present disclosure rather than to provide an exhaustive list of all possible implementations of embodiments of the present disclosure.

Although the above examples describe instruction handling and distribution in the context of execution units and logic circuits, other embodiments of the present disclosure can be accomplished by way of a data or instructions stored on a machine-readable, tangible medium, which when performed by a machine cause the machine to perform functions consistent with at least one embodiment of the disclosure. In one embodiment, functions associated with embodiments of the present disclosure are embodied in machine-executable instructions. The instructions can be used to cause a general-purpose or special-purpose processor that is programmed with the instructions to perform the steps of the present disclosure. Embodiments of the present disclosure may be provided as a computer program product or software which may include a machine or computer-readable medium having stored thereon instructions which may be used to program a computer (or other electronic devices) to perform one or more operations according to embodiments of the present disclosure. Alternatively, operations of embodiments of the present disclosure might be performed by specific hardware components that contain fixed-function logic for performing the operations, or by any combination of programmed computer components and fixed-function hardware components.

Instructions used to program logic to perform embodiments of the disclosure can be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘to,’ capable of/to,′ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer)

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. The blocks described herein can be hardware, software, firmware or a combination thereof.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “defining,” “receiving,” “determining,” “issuing,” “linking,” “associating,” “obtaining,” “authenticating,” “prohibiting,” “executing,” “requesting,” “communicating,” or the like, refer to the actions and processes of a computing system, or similar electronic computing device, that manipulates and transforms data represented as physical (e.g., electronic) quantities within the computing system's registers and memories into other data similarly represented as physical quantities within the computing system memories or registers or other such information storage, transmission or display devices.

The words “example” or “exemplary” are used herein to mean serving as an example, instance or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Also, the terms “first,” “second,” “third,” “fourth,” etc. as used herein are meant as labels to distinguish among different elements and may not necessarily have an ordinal meaning according to their numerical designation.

What is claimed is:

1. A processor comprising a core including virtualization support circuitry to:
retrieve a logical address from a virtual machine control structure (VMCS) associated with a virtual machine, the logical address corresponding to an instruction to be accessed;
translate the logical address to a guest virtual address;
invoke translation circuitry to translate the guest virtual address to a guest physical address, and translate the guest physical address to a host physical address; and
store at least one of the guest physical address or the host physical address in the VMCS.

2. The processor of claim 1, wherein the virtualization support circuitry is further to detect that a bit flag is set within a translate-on-entry control field of the VMCS as a trigger to perform the retrieve, the translate, the invoke, and the store; and
wherein the core is to further to execute a virtual machine monitor (VMM) to, responsive to a request, which calls for access to the instruction, to translate the logical address to the host physical address:
store the logical address in the VMCS associated with the virtual machine; and
retrieve, from the VMCS, the at least one of the guest physical address or the host physical address for emulating the instruction for the virtual machine.

3. The processor of claim 2, wherein the virtualization support circuitry is further to:
invoke address generation circuitry of the core to translate the logical address to the guest virtual address;
detect one of an address generation fault or a segmentation fault;
store, in the VMCS, a record of the address generation fault or the segmentation fault in relation to the logical address; and
perform a fault-based exit to the VMM.

4. The processor of claim 2, wherein the virtualization support circuitry is further to test access rights to memory pages corresponding to the guest physical address and the host physical address, and wherein the core is further to cause the virtualization support circuitry to:
detect a fault as a result of translation of the guest virtual address to the host physical address;
store, in the VMCS, a record of the fault in relation to the logical address; and
perform a fault-based exit to the VMM.

5. The processor of claim 2, wherein the VMM is further to:
examine the VMCS for a record of a fault stored in relation to the logical address; and
responsive to finding a record of the fault, one of process the fault or notify the virtual machine of the fault.

6. The processor of claim 2, wherein the virtualization support circuitry is further to:
test access rights to memory pages corresponding to the guest physical address and the host physical address;
load a VMM state from the VMCS; and
perform an exit to the VMM, with a reason for the exit comprising a translate-on-entry exit.

7. The processor of claim 2, wherein the VMM is to emulate the instruction to direct a hardware device on behalf of the virtual machine.

8. The processor of claim 1, wherein the translation circuitry comprises a page miss handler (PMH) circuit.

9. The processor of claim 1, wherein the virtualization support circuitry comprises the core executing a microcode.

10. The processor of claim 1, wherein the core is further to store the guest virtual address in a translation lookaside buffer entry associated with a current address space identifier for the virtual machine.

11. The processor of claim 10, wherein the virtualization support circuitry is further to invalidate the translation lookaside buffer entry in response to translation of the logical address to the guest virtual address.

12. A system comprising:
a memory to store a virtual machine storage structure (VMCS) associated with a virtual machine (VM) and to store a table in which to populate a plurality of logical addresses corresponding instructions to be emulated for the virtual machine; and
a processor operatively coupled to the memory, wherein the processor includes virtualization support circuitry to:
detect that a bit flag is set within a translate-on-entry control field of the VMCS associated with the virtual machine; and
responsive to detecting the bit flag, for each of at least some of the plurality of logical addresses:
retrieve a logical address from the table;
translate the logical address to a guest virtual address;
invoke a translation circuitry to translate the guest virtual address to a guest physical address and to translate the guest physical address to a host physical address; and
store at least one of the guest physical address or the host physical address in the table in relation to the logical address.

13. The system of claim 12, wherein the processor is further to execute a virtual machine monitor (VMM) to, responsive to a requirement to translate the plurality of logical addresses to a plurality of host physical addresses:
populate the table with the plurality of logical addresses; and
retrieve, from the table, one of a plurality of guest physical addresses or the plurality of host physical addresses for emulating the instructions for the virtual machine.

14. The system of claim 13, wherein the VMM is further to store, in the VMCS, an address of a location of the table in the memory, and wherein the virtualization support circuitry is further to access the table at the location in memory to retrieve the logical address.

15. The system of claim 13, wherein the virtualization support circuitry is further to:
invoke address generation circuitry of the processor to translate the logical address to the guest physical address;
detect one of an address generation fault or a segmentation fault;
store, in the VMCS, a record of the address generation fault or the segmentation fault in relation to the logical address; and
perform a fault-based exit to the VMM.

16. The system of claim 13, wherein the virtualization support circuitry is further to:
test access rights to memory pages corresponding to the guest physical address and the host physical address;
detect a permission fault as a result of testing the access rights;
store, in the VMCS, a record of the permission fault in relation to the logical address; and
perform a fault-based exit to the VMM.

17. The system of claim 13, wherein the virtualization support circuitry is further to:
indicate the logical address as valid in the table;
responsive to translating a second logical address of the plurality of logical addresses to second guest virtual address, detect a fault as a result of translating the second guest virtual address to a second host physical address;
store, in the VMCS, the fault in relation to the second logical address; and
perform a fault-based exit to the VMM.

18. The system of claim 17, wherein the VMM is further to, responsive to the fault-based exit:
move, from the table to the VMCS, a subset of the plurality of logical addresses indicated as valid in the table along with corresponding guest physical addresses and host physical addresses;
remove, from the table, the second logical address for which the fault resulted; and
request the virtualization support circuitry to resume translation of a subset of the plurality of logical addresses that remains in the table.

19. A method comprising:
retrieving, by virtualization support circuitry of a processor, a logical address from a virtual machine control structure (VMCS) associated with a virtual machine, the logical address corresponding to an instruction to be accessed;
translating, by the virtualization support circuitry, the logical address to a guest virtual address;
invoking, by the virtualization support circuitry, translation circuitry to: translate the guest virtual address to a guest physical address, and translate the guest physical address to a host physical address; and
storing, by the virtualization support circuitry, at least one of the guest physical address or the host physical address in the VMCS.

20. The method of claim 19, further comprising:
detecting, by the virtualization support circuitry, that a bit flag is set within a translate-on-entry control field of the VMCS as a trigger to perform the retrieving, the translating, the invoking, and the storing;
retrieving, by the virtualization support circuitry, the logical address from a plurality of VM entry control fields of the VMCS; and
translating, by invoking address generation circuitry of the processor, the logical address to the guest virtual address.

21. The method of claim 19, further comprising:
receiving, by a virtual machine monitor (VMM) executed by the processor, a virtual machine entry instruction for a virtual machine (VM);
responsive to execution of the virtual machine entry instruction, storing, by the VMM, the logical address in the VMCS associated with the virtual machine; and
retrieving, by the VMM from the VMCS, the at least one of the guest physical address or the host physical address for emulating the instruction for the virtual machine.

22. The method of claim 21, further comprising:
detecting one of an address generation fault or a segmentation fault;
storing, in the VMCS, a record of the address generation fault or the segmentation fault in relation to the logical address; and
performing a fault-based exit to the VMM.

23. The method of claim 21, further comprising:
testing access rights to memory pages corresponding to the guest physical address and the host physical address;
detecting a permission fault as a result of testing the access rights;
storing, in the VMCS, a record of the permission fault in relation to the logical address; and
performing a fault-based exit to the VMM.

24. The method of claim 21, further comprising:
examining, by the VMM, the VMCS for a record of a fault stored in relation to the logical address; and
responsive to finding the record of a fault, one of processing the fault or notifying the virtual machine of the fault.

25. The method of claim 21, further comprising:
loading, by the virtualization support circuitry, a VMM state from the VMCS; and
performing an exit to the VMM, with a reason for the exit comprising a translate-on-entry exit.
